(19) United States
(12) Patent Application Publication
(10) Pub. No.: US 2026/0106455 A1
(43) Pub. Date: Apr. 16, 2026

(54) OUTAGE RISK PREDICTION AND MANAGEMENT IN RADIAL ELECTRIC DISTRIBUTION GRIDS

(71) Applicant: The Texas A&M University System, College Station, TX (US)

(72) Inventors: Milad Soleimani, College Station, TX (US); Mladen Kezunovic, College Station, TX (US)

(73) Assignee: The Texas A&M University System, College Station, TX (US)

(21) Appl. No.: 19/341,546

(22) Filed: Sep. 26, 2025

Related U.S. Application Data
(60) Provisional application No. 63/700,050, filed on Sep. 27, 2024.

(51) Int. Cl. H02J 3/001; H02J 3/38; H02J 101/24

(52) U.S. Cl. CPC H02J 3/001; H02J 3/381; H02J 2101/24

(57) ABSTRACT

A system for load management is disclosed that includes a plurality of buildings, each building having an electric load and an electric vehicle charger, a plurality of electric power transformers, each electric power transformer coupled to a subset of the plurality of buildings and configured to provide electric power to each of subset of the buildings as a function of the electric load of each of the building and the electric vehicle charger and a controller coupled to the plurality of electric power transformers, the controller configured to receive load data for each of the plurality of transformers and generate control data for one or more of the electric vehicle chargers as a function of the load data for the transformer associated with the electric vehicle charger.

### RELATED APPLICATIONS

The present application claims benefit of and priority to U.S. Provisional Patent Application No. 63/700,050 filed Sep. 27, 2024, which is hereby incorporated by reference for all purposes as if set forth herein in its entirety.

### TECHNICAL FIELD

The present disclosure relates to power distribution systems and control strategies for distributed energy resources (DERs), and more specifically to a system and method for managing customer-owned resources in nano-grids (n-Grids) based on predictive State of Risk (SoR) assessment.

### BACKGROUND OF THE INVENTION

The electric power grid is undergoing significant transformation with the increasing deployment of DERs, including electric vehicles (EVs), photovoltaic (PV) systems, and battery energy storage systems (BESS). These resources, when deployed at the consumer level, referred to as n-Grids, introduce new challenges in balancing grid reliability, asset life, and end-user comfort.

Traditional utility control methods often treat DERS, including n-Grids, passively or optimize them solely for economic objectives such as minimizing consumer costs or maximizing utility profit. However, these approaches do not adequately account for grid reliability, particularly the operational risks associated with transformer degradation, feeder failure, and the inability of n-Grids to serve critical loads during outages.

There exists a need for systems and methods that can model and predict operational risk across utility and customer levels, and that can intelligently coordinate n-Grids and distribution grid operation to mitigate such risk. A framework that quantifies risk through predictive SoR metrics enables responsive control of n-Grids, which improves grid reliability under n-Grid integration while respecting user-defined preferences and operating constraints.

### SUMMARY OF THE INVENTION

A system for load management is disclosed that includes a plurality of buildings, each building having an electric load and an electric vehicle charger. Each of a plurality of electric power transformers are connected to a subset of the plurality of buildings and can provide electric power to each of the subset of the buildings as a function of the electric load of each of the building and the electric vehicle charger. A centralized controller is configured to receive load data for each of the plurality of transformers and generate control data for one or more of the electric vehicle chargers as a function of the load data for the transformer associated with the electric vehicle charger.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an n-Grid, in accordance with an example embodiment of the present disclosure;

FIG. 2 is a diagram of a system, in accordance with an example embodiment of the present disclosure;

FIG. 3 is diagram of an algorithm for utility-side control, referred to as a customer-owned resource management system (CORMS), in accordance with an example embodiment of the present disclosure;

FIG. 4 is a diagram of a system showing modes of operation of residential n-Grids in accordance with an example embodiment of the present disclosure;

FIG. 5A and FIG. 5B are diagrams of a system for providing fuzzy control of an n-Grid, in accordance with an example embodiment of the present disclosure;

FIG. 6, FIG. 7, and FIG. 8 are diagrams of a membership function of inputs in accordance with an example embodiment of the present disclosure;

FIG. 9 is a diagram of a system for distributed controls in accordance with an example embodiment of the present disclosure;

FIG. 10 is a diagram of an algorithm for processing data in accordance with an example embodiment of the present disclosure;

FIG. 11 as a diagram of a system for commercial grid applications and accordance with an example embodiment of the present disclosure;

FIG. 12 is a diagram of a system for providing grid functionality; and

FIG. 13 is a diagram of an algorithm for managing electric vehicle charging, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. Provisional Patent Application No. 63/700,050 filed Sep. 27, 2024, which is hereby incorporated by reference for all purposes as if set forth herein in its entirety.

A system and method are disclosed for managing n-Grids and other DERs based on predictive SoR assessment in n-Grids and utility distribution networks. The n-Grid architecture can include a number of subsystems, such as a rooftop PV device, a PV inverter, a battery, a battery charger, an electric vehicle charger and other local loads, which add a level of complexity to overall network management due to the non-linear behavior of the n-Grid.

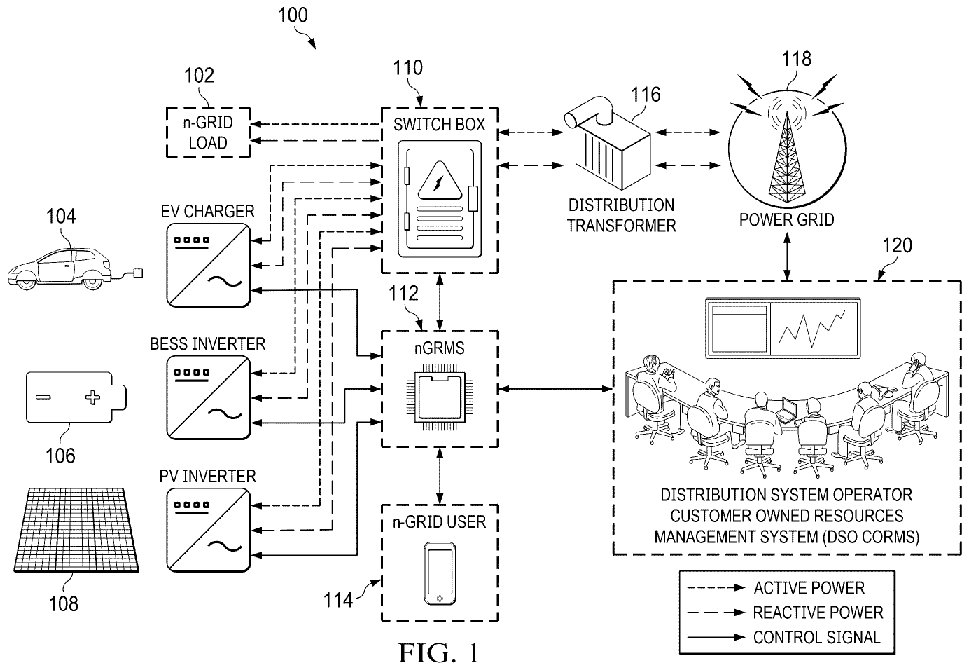

FIG. 1 is a diagram of an n-Grid 100, in accordance with an example embodiment of the present disclosure. N-Grid 100 includes n-Grid load 102, EV charger 104, BESS inverter 106, PV inverter 108, switchbox 110, n-Grid resource management system (nGRMS) 112, n-Grid user 114, distribution transformer 116, power grid 118 and distributed system operator customer owned resources management system (DSO CORMS 120), each of which can be implemented in hardware or a suitable combination of hardware and software.

n-Grid load 102 can be a residential load, a small business load, a light industrial load or other suitable loads that have known load profile characteristics, such as peak times, power factors, maximum and minimum power levels and so forth. In one example embodiment, n-Grid load 102 can be determined with an automated survey system or in other suitable manners.

EV charger 104 and associated electric vehicles contain charger components and control software that create a load profile component. In one example embodiment, electric vehicle charger 104 can respond to excess power availability from PV inverter 108, time of day charges from power grid 118 or other suitable variables, and may need to be coordinated with nGRMS 112 for optimal operation.

BESS inverter 106 and its associated battery systems contain charger components and control software that create a load profile component. In one example embodiment, BESS inverter 106 can respond to excess power availability from PV inverter 108, time of day charges from power grid 118 or other suitable variables, and may need to be coordinated with nGRMS 112 for optimal operation.

PV inverter 108 and its associated PV devices generates power that can be provided to the n-Grid, depending on weather conditions and time of day. PV inverter 108 typically does not function as a load but can experience fault conditions, such that it may cause transient disturbances on n-Grid 100.

Switchbox 110 can be a commercially available service switchbox that includes control functionality to allow nGRMS 112 to control connections between the subsystems of n-Grid 100. In one example embodiment, switchbox 110 can include protective relaying and other power system protective devices to allow components to be isolated during transient conditions.

nGRMS 112 can be a programmable controller or other suitable systems that can be configured to manage power flows and operation status of n-Grid 100 components. In one example embodiment, nGRMS 112 can be configured to assess SoR for EV charging readiness and battery energy sufficiency using real-time and forecasted data, including load demand, PV generation, user preferences, and outage likelihood.

n-Grid user 114 can be implemented as one or more algorithms that are loaded into the working memory of a processor that cause the processor, when executed, to generate a user interface and associated controls to allow the user to control the operation of subsystems and components of n-Grid 100. In one example embodiment, the user can modify load preferences, alerts and other suitable controls for n-Grid 100.

Distribution transformer 116 and power grid 118 can be commercially available power distribution system components, can be modified for use with n-Grid 100 or can have other suitable features that allow them to provide electrical power to and to receive electrical power from n-Grid 100. In one example embodiment, distribution transformer 116 and power grid 118 can include additional controls for optimal use with n-Grid 100, such as power factor control and load flow monitoring.

DSO CORMS 120 can be implemented as one or more algorithms that are loaded into the working memory of a processor that cause the processor, when executed, to generate one or more controls for managing customer owned resources. In one example embodiment, customer owned resources such as EV charger 104 and BESS inverter 106 can be remotely controlled to allow a distribution system to manage power system conditions, such as those caused by power shortages, downed lines and so forth. Under those emergency conditions, charging of electric vehicles or battery storage can be interrupted to manage load or for other suitable purposes.

In operation, n-Grid 100 provides service point support for customer owned resources, to ensure safe operation and to improve management of the power grid.

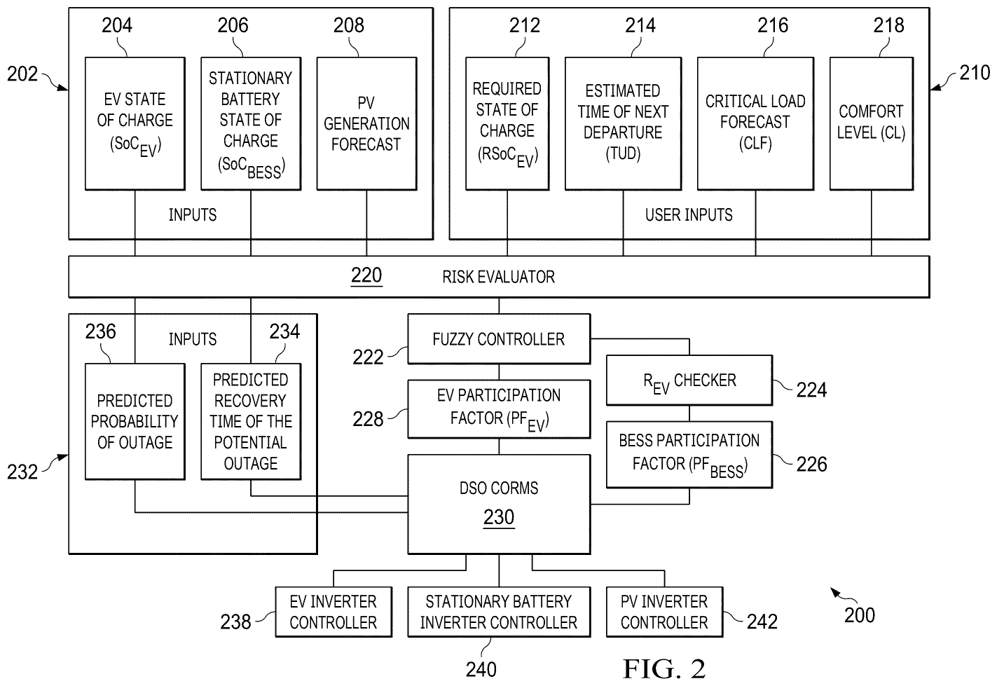

FIG. 2 is a diagram of a system 200, in accordance with an example embodiment of the present disclosure. System 200 includes inputs 202, EV state of charge system 204, stationary battery state of charge system 206, PV generation forecast system 208, user inputs 210, required state of charge system 212, estimated time of next departure system 214, critical load forecast system 216, comfort level system 218, risk evaluator system 220, fuzzy controller system 222, R_{EV} checker system 224, BESS participation factor system 226, EV participation factor system 228, predictive recovery time of the potential outage system 234, inputs 232, predicted probability of average system 236, DSO CORMS system 230, EV inverter controller system 238, stationary battery inverter controller system 240 and PV inverter controller system 242, each of which can be implemented in hardware or a suitable combination of hardware and software. System 200 is configured to assess SoR for EV charging readiness and battery energy sufficiency using real-time and forecasted data, including load demand, PV generation, user preferences, and outage likelihood.

Inputs 202 can be implemented as one or more algorithms that are loaded into the working memory of a processor that cause the processor, when executed, to receive real-time inputs from peripherals and subsystems, such as EV state of charge system 204, stationary battery state of charge system 206, and PV generation forecast system 208, and to process that data for input to subsystem components system 200 of either continuously, periodically, or on-demand.

EV state of charge system 204 can be implemented as one or more algorithms that are loaded into the working memory of a processor that cause the processor, when executed, to poll an electric vehicle charging system and determine the state of the charge of the electric vehicle. In one example embodiment, an electric vehicle can have a charge indicator system that can be read to determine how much charge has been stored by the electrical vehicle batteries, or other suitable information can also or alternatively be obtained.

Stationary battery state of charge system 206 can be implemented as one or more algorithms that are loaded into the working memory of a processor that cause the processor, when executed, to poll a stationary battery charge system and determine the level of charge of the batteries. In one example embodiment, a charge indicator can be read to determine how much charge the battery has, or other suitable information can also or alternatively be obtained

PV generation forecast system 208 can be implemented as one or more algorithms that are loaded into the working memory of a processor that cause the processor, when executed, to generate a forecast of the amount of energy that a PV system will generate, such as based on weather forecasts, historical data, or other suitable data. In one example embodiment, PV generation forecast system 208 can be used to determine an amount of charge that will be made available for charging an electric vehicle, stationary batteries, that can be provided to the grid, or other suitable information.

User inputs 210 can be implemented as one or more algorithms that are loaded into the working memory of a processor that cause the processor, when executed, to receive user inputs and process them for associated subsystems of system 200. In one example embodiment, user inputs can be used to configure subsystem components of system 200, such as for required state of charge system 212, estimated time of next departure system 214, critical load forecast system 216, comfort level system 218 or other suitable components, to allow a user to customize risk management settings.

Required state of charge system 212 can be implemented as one or more algorithms that are loaded into the working memory of a processor that cause the processor, when executed, to determine a required state of charge (RSoC) for electric vehicles, stationary batteries, or other suitable chargeable components. In one example embodiment, required state of charge system 212 can use load forecast data, historical data, history data, weather data, or other suitable data to determine a RSoC. In another example embodiment, the output can be in percent, the departure time can be a user-entered time when the EV owner needs the car to be charged, when at the departure time the state of charge should be at least equal to the RSoC.

Estimated time of next departure system 214 can be implemented as one or more algorithms that are loaded into the working memory of a processor that cause the processor, when executed, to determine an estimated time when a vehicle may be required. In one example embodiment, a user may park a vehicle and connect it to an electric vehicle charging system, and estimated time of next departure system 214 can determine how long the vehicle will likely be connected to the charging system, such as using historical data, a user-entered estimation of the time when the vehicle needs to be charged, or in other suitable manners.

Critical load forecast system 216 can be implemented as one or more algorithms that are loaded into the working memory of a processor that cause the processor, when executed, to evaluate critical loads such as HVAC equipment, refrigerator equipment, medical equipment, or other suitable equipment and can determine an estimate of the energy required for those critical loads. In one example embodiment, critical load forecast system 216 can determine the state of an electric grid or other suitable data and can utilize that state information to generate critical load forecasts. In another example embodiment, the critical load forecast can be the kWh demand in the next 24 hours that, if not supplied, will cause significant discomfort to the consumer. An array with 24 numbers can include the forecast data for the n-Grid user's critical load at each hour in the next 24 hours or other suitable user interface controls can be provided.

Comfort level system 218 can be implemented as one or more algorithms that are loaded into the working memory of a processor that cause the processor, when executed, to determine a comfort level (CL) for a dwelling or other suitable locations. In one example embodiment, when a dwelling is unoccupied, the CL can be lowered, and when the dwelling is occupied, the CL can be increased. Likewise, when the dwelling is unoccupied for long periods of time, such as over a vacation, the CL can be decreased during times when it would otherwise normally be higher. In one example embodiment, the CL can be a number between 0 and 10 where 0 represents the most savings/least comfort and 10 is the lowest savings/highest comfort. When the CL is low, the controller can delay charging as needed to achieve savings. When the CL is high, the controller can minimize charging delays to ensure that the electric vehicle or stationary batteries are charged as much as possible. The CL in this context can represent the tolerance of an electric vehicle owner to the vehicle not being charged when needed for a trip. For stationary batteries, a low CL can represent whether the n-Grid owner prefers to offer services to the utility grid rather than keeping the battery fully charge and a high CL means the opposite. CL can represent the opposite of a state of risk tolerance of n-Grids for not meeting their energy needs.

Risk evaluator system 220 can be implemented as one or more algorithms that are loaded into the working memory of a processor that cause the processor, when executed, to evaluate risks associated with system component operation, power system availability, weather, and other suitable systems and variables. In one example embodiment, risk evaluator system 200 can be used to provide inputs to various systems to ensure that systems with high levels of importance are maintained and that systems with lower level of importance can be interrupted. In another example embodiment, risk evaluator 20 can calculate risk indices associated with EV charging and energy sufficiency based on inputs provided.

Fuzzy controller system 222 can be implemented as one or more algorithms that are loaded into the working memory of a processor that cause the processor, when executed, to receive data from risk evaluator system 220 and to generate controls for EV risk checker system 224, EV participation factor system 228 and other suitable systems. In one example embodiment, fuzzy controller can generate best estimates of control variables to improve the reliability of system components and to minimize risk of outage, such as by converting uncertain or imprecise inputs into clear indices, to facilitate generation of control data. The CL, electric vehicle risk, the risk for n-Grid sufficiency and other suitable data can be included in this category, where fuzzy logic is a suitable option to provide a specific output based on fuzzy inputs. The output of fuzzy controller system 222 for each EV can be an index for the electric vehicle participation factor (PF_{EV}). A similar process can be used for the stationary battery, to generate a stationary battery participation factor (PF_{BESS}). The output of the fuzzification layer for the electric vehicle risk and the n-Grid sufficient can be used to represent the risk assessment levels for the electric vehicle and stationary battery, respectively.

Electric vehicle risk checker system 224 can be implemented as one or more algorithms that are loaded into the working memory of a processor that cause the processor, when executed, to determine a risk of an electric vehicle outage based on current system parameters. In one example embodiment, electric vehicle risk checker system 224 can generate risk data for an electric vehicle charger or other suitable data, to determine EV charging feasibility by comparing required charge levels and available charging times.

Stationary battery participation factor system 226 can be implemented as one or more algorithms that are loaded into the working memory of a processor that cause the processor, when executed, to generate a numeric index that represents a readiness of stationary battery resources for grid participation. In one example embodiment, stationary battery participation factor system 226 can utilize an algorithmic process such as that discussed further herein to generate the numeric index, or other suitable processes.

EV participation factor system 228 can be implemented as one or more algorithms that are loaded into the working memory of a processor that cause the processor, when executed, to generate a numeric index that represents a readiness of electric vehicle battery resources for grid participation. In one example embodiment, EV participation factor system 228 can utilize an algorithmic process such as that discussed further herein to generate the numeric index, or other suitable processes.

Predictive recovery time of the potential outage system 234 can be implemented as one or more algorithms that are loaded into the working memory of a processor that cause the processor, when executed, to generate an estimate that the distribution system operator (DSO) has of the time that it takes to recover from a potential outage, such as an estimate of the time that the utility repair and maintenance crew will need to go to the location of failure and the estimate of the time needed to restore the utility grid.

Outage inputs 232 can be implemented as one or more algorithms that are loaded into the working memory of a processor that cause the processor, when executed, to predict recovery time, outage probability and other risk assessment factors.

Predicted probability of average system 236 can be implemented as one or more algorithms that are loaded into the working memory of a processor that cause the processor, when executed, to generate probability data for an outage that the DSO calculates based on the n-Grid probability of outage.

DSO CORMS system 230 can be implemented as one or more algorithms that are loaded into the working memory of a processor that cause the processor, when executed, to integrate the indices and data generated by system 200 into broader grid management strategies and to generate control commands. DSO CORMS system 230 can be used to manage system 200 resources for near term and real-time conditions, based on separate control strategies and as discussed further herein.

EV inverter controller system 238 can be implemented as one or more algorithms that are loaded into the working memory of a processor that cause the processor, when executed, to manage EV inverter operations, such as to adjust charging rate, power factor and other electrical parameters. In one example embodiment, EV inverter controller system 238 can stop charging an EV when power is needed for a higher priority load or can perform other suitable functions as discussed and described herein.

Stationary battery inverter controller system 240 can be implemented as one or more algorithms that are loaded into the working memory of a processor that cause the processor, when executed, to manage stationary battery inverter operations, such as to adjust charging rate, power factor and other electrical parameters. In one example embodiment, stationary battery inverter controller system 240 can stop charging a stationary battery when power is needed for a higher priority load or can perform other suitable functions as discussed and described herein.

PV inverter controller system 242 can be implemented as one or more algorithms that are loaded into the working memory of a processor that cause the processor, when executed, to manage PV inverter operations, such as to adjust charging rate, power factor and other electrical parameters. In one example embodiment, PV inverter controller system 242 can modify power flows on system 200, such as to route power to the utility grid or battery chargers, or can perform other suitable functions as discussed and described herein.

System 200 can be deployed within nGRMS 112 or other suitable system to evaluate multiple uncertain inputs and generate n-Grid participation indices, PF_{EV} data, PF_{BESS} data and other suitable data that can be transmitted to a utility-side control system.

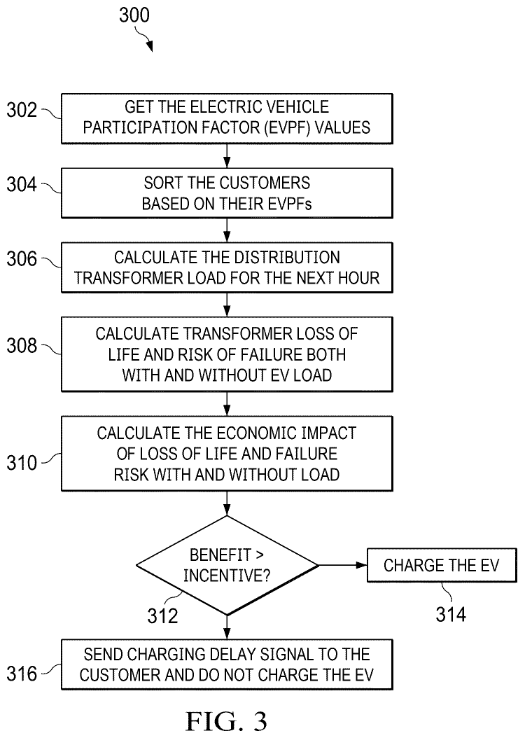

FIG. 3 is diagram of an algorithm 300 for utility-side control, referred to as a customer-owned resource management system (CORMS), in accordance with an example embodiment of the present disclosure. Algorithm 300 can be implemented in hardware or a suitable combination of hardware and software.

Algorithm 300 begins at 302, where electric vehicle participation factor values are obtained. In one example embodiment, the electric vehicle participation factor values can be associated with one or more electric vehicles, can be based on estimated or measured electric vehicle charging data or can be determined in other suitable manners. The algorithm then proceeds to 304.

At 304, customers are sorted based on their electric vehicle participation factors. In one example embodiment, customers can be identified for a specific transformer, for an entire distribution subsystem or in other suitable manners. The algorithm then proceeds to 306.

At 306, the distribution transformer load for the next hour is calculated as a function of the number of electric vehicles that are being charged. In one example embodiment, stationary battery loads can also be included, or other suitable processes can also or alternatively be performed as discussed herein. The algorithm then proceeds to 308.

At 308, transformer loss of life and transformer risk of failure estimates are calculated both with and without the electric vehicle load, the stationary battery load or other suitable loads. The algorithm then proceeds to 310.

At 310, the economic impact from loss of transformer life and transformer failure risk with and without the charger load are determined. In one example embodiment, the economic impact can be calculated as a function of a number of chargers, a type of charger and so forth. The algorithm then proceeds to 312.

At 312, it is determined whether the economic benefit is greater than the incentive. If it is determined that the economic benefit is greater than the incentive, then the algorithm proceeds to 314 and one or more of the electric vehicles are charged. If it is determined that the economic benefit is not greater than the incentive, the algorithm proceeds to 316 and a charging delay signal is generated and transmitted to one or more customers to cause their electric vehicle inverters not to charge their electric vehicles.

In operation, algorithm 300 can be used to aggregate participation indices across multiple n-Grids and execute optimization routines in both day-ahead and real-time windows to mitigate transformer aging, avoid undervoltage events, and reduce overall SoR.

Algorithm 300 enables intelligent, risk-aware dispatch of n-Grids by solving linearized optimization problems that incorporate transformer SoR functions based on thermal degradation models. The system also includes a real-time EV charging control algorithm that dynamically adjusts charging behavior based on predicted benefit-to-cost ratios of deferring demand.

The present disclosure provides systems and methods for comprehensive SoR assessment and resource management system for n-Grids that can evaluate and manage the risk associated with insufficient EV charging levels and inadequate energy supply for critical loads during outages. The disclosure provides algorithms and system management strategies that can be used to systematically calculate risk indices that DSOs can utilize to optimize resource deployment, enhance grid resilience, and ensure user comfort and energy sufficiency.

The disclosed systems and methods formulate two primary SoR categories for n-Grids:
1) EV Charging Insufficiency: the risk that the EV does not reach an adequate state of charge (SoC) for its next scheduled trip.
2) Energy Supply Insufficiency: the risk that BESS and PV generation cannot supply sufficient energy to support critical n-Grid loads during utility outages.

For EV charging, an EV must have enough battery charge for the planned trip at the time of departure. If the EV does not have enough charge for the next trip, it is not deployable. This requirement leads to two important factors for the SOR assessment: a) the predicted characteristics of the next trip and b) the charging time. Those factors are addressed using a CL index that is defined to capture the EV user's risk tolerance. The inputs which are used in the SoR assessment are: (a) EV SoC, (b) required SoC for the next trip (RSoC), and (c) estimated time of next departure.

The time required (TR) to have the EV charged to a predetermined level can be calculated as:

$${T}_{R} = \frac{( R S o {C}_{E V} - S o {C}_{E V} ) \cdot {BC}_{E V}}{C h {P}_{E V}} \qquad ( 1 )$$

where BC_{EV} is EV battery capacity and ChP_{EV} is the nominal charging power of EV charger. The idle hours when the EV is parked and connected but is not charging in case of an outage at tᵢ can be calculated as:

$${T}_{idle} ( {t}_{i} ) = {T}_{U D} - {T}_{R} - R T ( {t}_{i} ) \qquad ( 2 )$$

where T_{UD} is the number of time steps until departure and RT(tᵢ) is the recovery time if a fault happens at time tᵢ. The SoR of not having enough EV battery charge if an outage takes place at tᵢ is defined as the conditional probability of having no idle time for EV if an outage happens at tᵢ which is shown by O(tᵢ). It is shown below:

$${R}_{E V} ( {t}_{i} ) = P ( {T}_{idle} ( {t}_{i} ) < 0 ) \qquad ( 3 )$$

As explained herein, the probability of an outage can be calculated for each bus, and consequently, each connected consumer. Po(tᵢ) represents the probability of an O(tᵢ) occurrence. Therefore, R_{EV}(tᵢ) can be calculated as shown below:

$${R}_{E V} ( {t}_{i} ) = \{ \begin{matrix}{R}_{E V} ( {t}_{i} ) = 0 & {T}_{idle} ( {t}_{i} ) \geq 0 \\ {R}_{E V} ( {t}_{i} ) = {P}_{O} ( {t}_{i} ) & {T}_{idle} ( {t}_{i} ) < 0 \\ {R}_{E V} ( {t}_{i} ) = 1 & {T}_{UD} < {T}_{R}\end{matrix} \qquad ( 4 )$$

Using R_{EV}(tᵢ), the SOR of EV insufficient charge when there is insufficient data to predict TPR number of time steps can be estimated from the average of SoRs for different incidents, as shown below:

$${R}_{E V} = \frac{{\sum }_{j = i}^{i + {T}_{PR}} {R}_{E V} ( {t}_{i} + {T}_{P R} )}{{T}_{P R}} \qquad ( 5 )$$

To formulate the SOR for the n-Grid energy sufficiency (RnGES), an important factor is to evaluate whether the BESS and PV can provide enough electric energy to supply the electricity needed for critical load. The energy needed by the consumer at time step tj is shown below,

$$NE ( {t}_{j} ) = ( C L ( {t}_{j} ) + C h {P}_{E V} \cdot {R}_{E V} ( {t}_{j} ) - {G}_{P V} ( {t}_{j} ) ) \cdot TS \qquad ( 6 )$$

where CL is the critical load, G_{PV} is PV generation, ChPB_{ESS} is the nominal charging power of BESS inverter and TS is the time step duration. The idle energy in the stationary BESS that will not be used to feed the critical load in case an outage happens at tᵢ can be calculated as

$${E}_{i d l e} ( {t}_{i} ) = S o {C}_{B E S S} ( {t}_{i} ) \cdot {BC}_{B E S S} - {\sum }_{j = i}^{i + RT ( {t}_{i} )} NE ( {t}_{j} ) \qquad ( 7 )$$

where BC_{BESS} is the stationary battery capacity. The BESS SOR if an outage takes place at tᵢ is defined as the conditional probability of having no idle energy for BESS if an outage happens at tᵢ:

$${R}_{n G E S} ( {t}_{i} ) = P ( {E}_{i d l e} ( {t}_{i} ) \leq 0 ) \qquad ( 8 )$$

An nGRMS is assumed to be available in the n-Grid's location. It takes owner's inputs and energy resources conditions and sends an index reflecting EV and BESS charging status to the DSO CORMS and receives command signals from DSO that control the EV and BESS inverters. The disclosed systems and methods are designed for both the EV charging and BESS management purposes, but can be used to manage each element independently. The owner's nGRMS sends inputs to the DSO CORMS and receives the feedback data in real time. The main modules of the nGRMS are explained elsewhere herein.

To determine the optimal value of the BESS charged capacity that the DSO should get from the n-Grid and the usage of BESS capacity, an optimization problem is defined as shown below,

$$Min {\sum }_{i = 1}^{{T}_{P R}} {\sum }_{j ∈ {N}_{T r}} {\sum }_{k ∈ n {G}_{j}} [ \begin{matrix}{\overbrace{{RCo}_{ij} ( Δ {T}_{PR} , {P}_{Tr}^{*} ( i - 1 ) , {P}_{Tr}^{*} ( i ) ) \cdot ( {P}_{BESS , j , k}^{ch} ( i ) - {P}_{BESS , j , k}^{dch} ( i ) )} …}^{Impact of transformer risk} \\ … + {\overbrace{{Price}_{BESS , k} ( i ) \cdot ( {P}_{BESS , j , k}^{ch} ( i ) + {P}_{BESS , j , k}^{dch} ( i ) ) \cdot Δ {T}_{PR}}}^{Paid Incentives}\end{matrix} ] \qquad ( 9 )$$

with the following constraints

$$0 \leq {P}_{B E S S , j , k}^{c h} + {P}_{B E S S , j , k}^{d c h} \leq {P}_{B E S S , j , k , max} \qquad ( 10 )$$

$$- {SoC}_{BESS , j , k} ( 0 ) \leq ( {\sum }_{i = 1}^{h} \frac{{P}_{B ESS , j , k}^{c h} ( i ) - {P}_{B ESS , j , k}^{d c h} ( i )}{B E S {S}_{cap , j , k}} ) \cdot Δ {T}_{P R} \leq 1 - {SoC}_{BESS , j , k} ( 0 ) h ∈ \{ 1 , 2 , … , {T}_{P R} \} \qquad ( 11 )$$

$${\sum }_{i = 1}^{{T}_{P R}} ( {P}_{B ESS , j , k}^{c h} ( i ) + {P}_{B ESS , j , k}^{d c h} ( i ) ) = 0 \qquad ( 12 )$$

$$k ∈ n {G}_{j} , j ∈ {N}_{T r} \qquad ( 13 )$$

where ΔT_{PR} is the duration of each time-step P_{BESS,j,k} is the amount of power of BESS inverter controlled by the DSO, taken from the n-Grid k downstream of transformer j; P_{BESS,j,k}, max is the power rating of BESS inverter of n-Grid k downstream of transformer j that is available for DSO use; and Nor is the set of all transformers. nGⱼ is the set of all n-Grids connected to transformer j. RCoᵢⱼ and RCᵢⱼ are the coefficient and constant of the linear formulation of SoR for transformer j at time step i.

$${P}_{T r}^{*}$$

is the prediction for transformer Tr loading.

The loading of each transformer can be estimated using the prediction that the DSO obtains from the estimate of the load electricity consumption as well as the power of BESS taken by the n-Grids that are connected to the transformer represented by P_{BESS,j,k}, as shown below,

$${P}_{Tr , j} ( i ) = {\sum }_{k ∈ n {G}_{j}} ( {P}_{nG , k} ( i ) + {P}_{BESS , j , k} ( i ) ) \qquad ( 14 )$$

where nGⱼ is the set of n-Grids downstream of the transformer j. P_{nG,k} is the net power of n-Grid k excluding stationary BESS-stored energy.

The price of deploying each battery energy storage system can be determined using the participation factor calculated by nGRMS as shown in the equation below:

$${Price}_{BESS , k} ( i ) = {P F}_{k}^{B E S S} ( i ) \cdot {Price}_{max} \qquad ( 15 )$$

where Priceₘₐₓ is the maximum price of deploying 1 kWh of battery energy storage predetermined in the contract between the utility and n-Grids.

To solve the optimization problem, the matrix form of the variables should be defined. The form of the optimization problem in matrix form is shown below:

$$Min C \cdot {P}_{B ESS , Mat} \qquad ( 16 )$$

### Constraints:

$$A \cdot {P}_{B ESS , Mat} \leq b \qquad ( 17 )$$

$${A}_{e q} {P}_{B ESS , Mat} = {b}_{e q} \qquad ( 18 )$$

$$l b \leq {P}_{B ESS , Mat} \leq ub \qquad ( 19 )$$

The matrix of the optimization variables is shown below:

$${P}_{ch , BESS , Mat} = \begin{matrix}[ {P}_{BESS , 1 , 1}^{d c h} ( 1 ) & {P}_{BESS , 1 , 2}^{d c h} ( 2 ) & … & {P}_{BESS , 1 , last}^{d c h} ( {T}_{P R} ) & {P}_{B ESS , 2 , 1}^{d c h} ( 1 ) & … & {{P}_{B ESS , last , last}^{d c h} ( {T}_{P R} ) ]}^{T}\end{matrix} \qquad ( 20 )$$

$${P}_{dch , BESS , Mat} = \begin{matrix}[ {P}_{BESS , 1 , 1}^{d c h} ( 1 ) & {P}_{BESS , 1 , 2}^{d c h} ( 2 ) & … & {P}_{BESS , 1 , last}^{d c h} ( {T}_{P R} ) & {P}_{B ESS , 2 , 1}^{d c h} ( 1 ) & … & {{P}_{B ESS , last , last}^{d c h} ( {T}_{P R} ) ]}^{T}\end{matrix} \qquad ( 21 )$$

$${P}_{BESS , Mat} = [ \begin{matrix}{P}_{ch , BESS , Mat} \\ {P}_{dch , BESS , Mat}\end{matrix} ] \qquad ( 22 )$$

Using (x+1), matrix C can be obtained:

$${C}_{c h} = [ \begin{matrix}{RCo}_{11} & {RCo}_{12} & … & {RCo}_{1 {T}_{PR}} & {RCo}_{21} & … & {RCo}_{{lastT}_{PR}}\end{matrix} ] \qquad ( 23 )$$

$${C}_{d c h} = [ \begin{matrix}- {RCo}_{11} & - {RCo}_{12} & … & - {RCo}_{1 {T}_{PR}} & - {RCo}_{21} & … & - {RCo}_{{lastT}_{PR}}\end{matrix} ] \qquad ( 24 )$$

$$C = \begin{matrix}[ {C}_{c h} & {C}_{d c h} ]\end{matrix} \qquad ( 25 )$$

Inequality (11) can be defined to two separate inequalities:

$$( {\sum }_{j = 1}^{h} \frac{{P}_{B ESS , i}^{c h} ( j ) - {P}_{B ESS , i}^{d c h} ( j )}{B E S {S}_{cap , i}} ) \cdot Δ {T}_{P R} \leq 1 - S O {C}_{i} ( 0 ) i ∈ nG , h ∈ \{ 1 , 2 , … , {T}_{P R} \} \qquad ( 26 )$$

$$- ( {\sum }_{j = 1}^{h} \frac{{P}_{B ESS , i}^{c h} ( j ) - {P}_{B ESS , i}^{d c h} ( j )}{B E S {S}_{cap , i}} ) \cdot Δ {T}_{P R} \leq SO {C}_{i} ( 0 ) i ∈ nG , h ∈ \{ 1 , 2 , … , {T}_{P R} \} \qquad ( 27 )$$

Using (26), matrix A₁ can be calculated as shown below:

$${A}_{1 k , ch} = [ \begin{matrix}1 & 0 & 0 & {\overbrace{…}}^{{T}_{PR} - 4} & 0 \\ 1 & 1 & 0 & … & 0 \\ 1 & 1 & 1 & … & 0 \\ ⋮ & ⋮ & ⋮ & ⋱ & ⋮ \\ 1 & 1 & 1 & … & 1\end{matrix} ] \cdot \frac{Δ {T}_{PR}}{{BESS}_{cap , k}} k ∈ N {G}_{Tr}^{i} , i ∈ {N}_{T r} \qquad ( 28 )$$

$${A}_{1 k , dch} = - [ \begin{matrix}1 & 0 & 0 & {\overbrace{…}}^{{T}_{PR} - 4} & 0 \\ 1 & 1 & 0 & … & 0 \\ 1 & 1 & 1 & … & 0 \\ ⋮ & ⋮ & ⋮ & ⋱ & ⋮ \\ 1 & 1 & 1 & … & 1\end{matrix} ] \cdot \frac{Δ {T}_{PR}}{{BESS}_{cap , k}} k ∈ N {G}_{Tr}^{i} , i ∈ {N}_{T r} \qquad ( 29 )$$

$${A}_{1 , ch} = [ \begin{matrix}{A}_{11 , ch} & {[ 0 ]}_{{T}_{PR} \times {T}_{PR}} & {[ 0 ]}_{{T}_{PR} \times {T}_{PR}} & … & {[ 0 ]}_{{T}_{PR} \times {T}_{PR}} \\ {[ 0 ]}_{{T}_{PR} \times {T}_{PR}} & {A}_{12 , ch} & {[ 0 ]}_{{T}_{PR} \times {T}_{PR}} & … & {[ 0 ]}_{{T}_{PR} \times {T}_{PR}} \\ {[ 0 ]}_{{T}_{PR} \times {T}_{PR}} & {[ 0 ]}_{{T}_{PR} \times {T}_{PR}} & {A}_{13 , ch} & … & {[ 0 ]}_{{T}_{PR} \times {T}_{PR}} \\ ⋮ & ⋮ & ⋮ & ⋱ & ⋮ \\ {[ 0 ]}_{{T}_{PR} \times {T}_{PR}} & {[ 0 ]}_{{T}_{PR} \times {T}_{PR}} & {[ 0 ]}_{{T}_{PR} \times {T}_{PR}} & … & {A}_{1 last , ch}\end{matrix} ] \qquad ( 30 )$$

$${A}_{1 , dch} = [ \begin{matrix}{A}_{11 , dch} & {[ 0 ]}_{{T}_{PR} \times {T}_{PR}} & {[ 0 ]}_{{T}_{PR} \times {T}_{PR}} & … & {[ 0 ]}_{{T}_{PR} \times {T}_{PR}} \\ {[ 0 ]}_{{T}_{PR} \times {T}_{PR}} & {A}_{21 , dch} & {[ 0 ]}_{{T}_{PR} \times {T}_{PR}} & … & {[ 0 ]}_{{T}_{PR} \times {T}_{PR}} \\ {[ 0 ]}_{{T}_{PR} \times {T}_{PR}} & {[ 0 ]}_{{T}_{PR} \times {T}_{PR}} & {A}_{31 , dch} & … & {[ 0 ]}_{{T}_{PR} \times {T}_{PR}} \\ ⋮ & ⋮ & ⋮ & ⋱ & ⋮ \\ {[ 0 ]}_{{T}_{PR} \times {T}_{PR}} & {[ 0 ]}_{{T}_{PR} \times {T}_{PR}} & {[ 0 ]}_{{T}_{PR} \times {T}_{PR}} & … & {A}_{last 1 , dch}\end{matrix} ] \qquad ( 31 )$$

$${A}_{1} = [ \begin{matrix}{A}_{1 , ch} & {A}_{1 , dch}\end{matrix} ] \qquad ( 32 )$$

Using (30), matrix b₁ also can be calculated:

$${b}_{1 k} = ( 1 - S o {C}_{k} ( 0 ) ) \cdot {[ \begin{matrix}1 & 1 & {\overbrace{…}}^{{T}_{PR} - 3} & 1\end{matrix} ]}^{T} \qquad ( 33 )$$

$${b}_{1} = \begin{matrix}[ {b}_{11} & {b}_{12} & … & {b}_{1 last} ]\end{matrix} \qquad ( 34 )$$

Then use (31) to derive matrix A₂.

$${A}_{2} = - {A}_{1} \qquad ( 35 )$$

Similarly, matrix b2 can be found as shown below:

$${b}_{2 k} = S o {C}_{k} ( 0 ) \cdot {[ \begin{matrix}1 & 1 & {\overbrace{…}}^{{T}_{PR} - 3} & 1\end{matrix} ]}^{T} \qquad ( 36 )$$

$${b}_{2} = [ \begin{matrix}{b}_{21} & {b}_{22} & … & {b}_{2 last}\end{matrix} ] \qquad ( 37 )$$

the inequality matrix of the optimization problem can be calculated as shown below:

$$A = [ \begin{matrix}{A}_{1} \\ {A}_{2}\end{matrix} ] \qquad ( 38 )$$

$$b = [ \begin{matrix}{b}_{1} \\ {b}_{2}\end{matrix} ] \qquad ( 39 )$$

Equation (20) can be obtained as shown below:

$${A}_{eq , ch} = {[ \begin{matrix}{[ 1 ]}_{1 \times {T}_{P R}} & {[ 0 ]}_{1 \times {T}_{P R}} & {[ 0 ]}_{1 \times {T}_{P R}} & … & {[ 0 ]}_{1 \times {T}_{P R}} \\ {[ 0 ]}_{1 \times {T}_{P R}} & {[ 1 ]}_{1 \times {T}_{P R}} & {[ 0 ]}_{1 \times {T}_{P R}} & … & {[ 0 ]}_{1 \times {T}_{P R}} \\ {[ 0 ]}_{1 \times {T}_{P R}} & {[ 0 ]}_{1 \times {T}_{P R}} & {[ 1 ]}_{1 \times {T}_{P R}} & … & {[ 0 ]}_{1 \times {T}_{P R}} \\ ⋮ & ⋮ & ⋮ & ⋱ & ⋮ \\ {[ 0 ]}_{1 \times {T}_{P R}} & {[ 0 ]}_{1 \times {T}_{P R}} & {[ 0 ]}_{1 \times {T}_{P R}} & … & {[ 1 ]}_{1 \times {T}_{P R}}\end{matrix} ]}_{( Number of BESSs ) \times ( {T}_{PR} - Number of BESSs )} \qquad ( 40 )$$

$${A}_{eq , dch} = - {A}_{eq , ch} \qquad ( 41 )$$

$${A}_{e q} = \begin{matrix}[ {A}_{eq , ch} & {A}_{eq , dch} ]\end{matrix} \qquad ( 42 )$$

$${b}_{e q} = {[ \begin{matrix}0 & 0 & … & 0\end{matrix} ]}_{t \times Number of BESSs}^{T} \qquad ( 43 )$$

The lower band (lb) matrix and upper band (ub) matrix are as follows:

$$l b = {[ \begin{matrix}0 & 0 & … & 0\end{matrix} ]}_{t \times Number of BESSs}^{T} \qquad ( 44 )$$

$$ub = \begin{matrix}[ {P}_{BESS , 1 , max} & {P}_{BESS , 2 , max} & … & {{P}_{BESS , Number of BESSs , max} ]}^{T}\end{matrix} \qquad ( 45 )$$

The matrix linear formulation of the optimization problem can be used. For the DSO CORMS, the algorithm of real-time decision making for EV charging can be implemented as discussed herein.

The incentive for n-Grid i for the charging of its EV being postponed can be calculated using PF_{EV}. The incentive factor (IF) can be adjusted based on the needs of the distribution grid operator and utility.

$$Inc ( i ) = IF \cdot {PF}_{E V} ( i ) \cdot EP \cdot ChP ( i ) \qquad ( 46 )$$

A function that the DSO can deploy is shown below:

$${Cost}_{{Tr}_{j}} = {\overbrace{{R}_{L o L} ( I {m}_{L o L} \vert {X}_{j} ( T {r}_{L , j} , {T}_{A m b i e n t} ) )}}^{Impact of Loss of Life} + {\overbrace{{R}_{f} ( I {m}_{f} \vert {X}_{j} ( T {r}_{L , j} , {T}_{A m b i e n t} ) )}}^{Impact of Failure} \qquad ( 47 )$$

where X is the operating condition of transformers and includes transformer loading and ambient temperature. The loading of transformer j can be obtained using (48).

$$T {r}_{L , j} = {Load}_{j} + {\sum }_{i ∈ {EV\_set}_{j}} {α}_{i j} {P}_{{EV}_{ij}} \qquad ( 48 )$$

EV_setⱼ is the set of all EVs connected to transformer j. P_{EV}_{ᵢⱼ} is the power of EV charger i connected to transformer j. Tr_set can be a set of all distribution transformers in the utility grid under study. One formulation of the optimization problem that can be solved to assist the operator is:

$$Min {\sum }_{j ∈ Tr\_set} {Cost}_{{Tr}_{j}} \qquad ( 49 )$$

The constraint is:

$${α}_{i j} = \{ \begin{matrix}0 & {EV}_{ij} is not charging \\ 1 & {EV}_{ij} is charging\end{matrix} i ∈ {EV\_set}_{j} , j ∈ TR\_set \qquad ( 50 )$$

If the difference, which equals the saving of postponing the EV demand and not charging it for that hour, is more than the incentive paid to the owner, then charging is postponed and the operator sends the control (dispatch) signal to the household EV charging management system to postpone the charging of the EV. This process can continue for one or more households.

The optimum point is achieved by selecting the n-Grid with the least value of PF_{EV} one-by-one, since they will receive the smallest amount of incentive if the charging of their EVs is delayed. The value will be evaluated if the paid incentive is less than the benefit that the distribution utility grid will gain from this delayed charging. If the value of the benefit is more than the incentive, the delayed signal will be sent to the EV, and that EV will be removed from the set for that time slot. The EV with the next lowest PF_{EV} will be selected, and the same procedure will continue until the incentive is higher than the benefit.

The use of distributed generation and battery energy storage systems is emerging in electric distribution grid. For electric utility company maintenance staff and electric DSOs, it can considerably help managing these resources if one could predict which part of the grid may experience electric outage soon. The disclosed technology proposes s an algorithm that provides a probability of outage to each consumer for the foreseeable future. This algorithm can be implemented by DSOs as independent software or can be deployed as an addition to the existing distribution asset management systems.

The present disclosure provides risk-based management and mitigation systems and methods to coordinate diverse consumer-owned energy resources consisting of energy storage, either mobile (EV) or stationary (BESS), and PV generation to provide benefits to the owner while also supporting the utility grid. The disclosed systems and methods can minimize the risk of electricity delivery interruption to the consumer or degradation and failure of utility assets.

Although EVs account for a small percentage of vehicles on the market today, adoption is accelerating and gaining momentum. If this leads to high penetration of EV chargers in some parts of a given distribution grid, utility assets, such as transformers, may frequently overload in high-concentration areas, which may lead to accelerated aging and high risk of failure. Specific distribution grid feeders may also be at high risk of failure from surrounding overgrown vegetation, deterioration from wear and tear, and extreme weather. Local consumer-owned energy resources, if properly managed, can be used to sustain electricity supply to their loads at time of grid failures.

The present disclosure provides decision-making tools to minimize the impact of loss of load supply during outages by enabling and incentivizing consumers to provide energy resource support to the grid when needed to avoid or mitigate outages. The disclosed systems and methods use the state of risk prediction and management methodology with optimized decision-making solutions for coordinating consumer and grid resources to reduce and mitigate the state of risk of electricity supply interruptions.

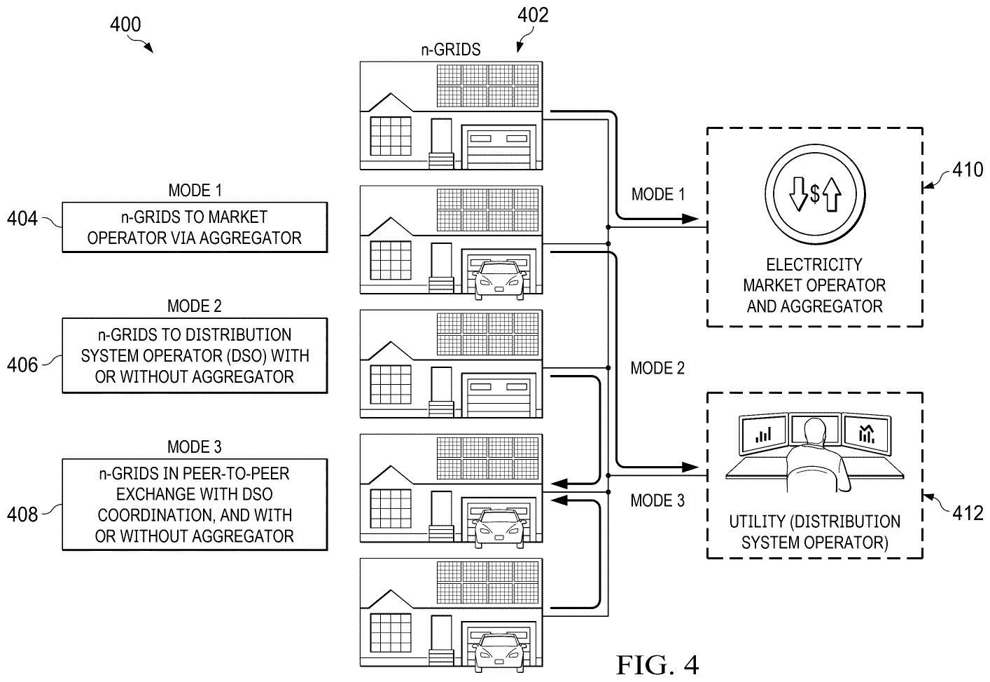

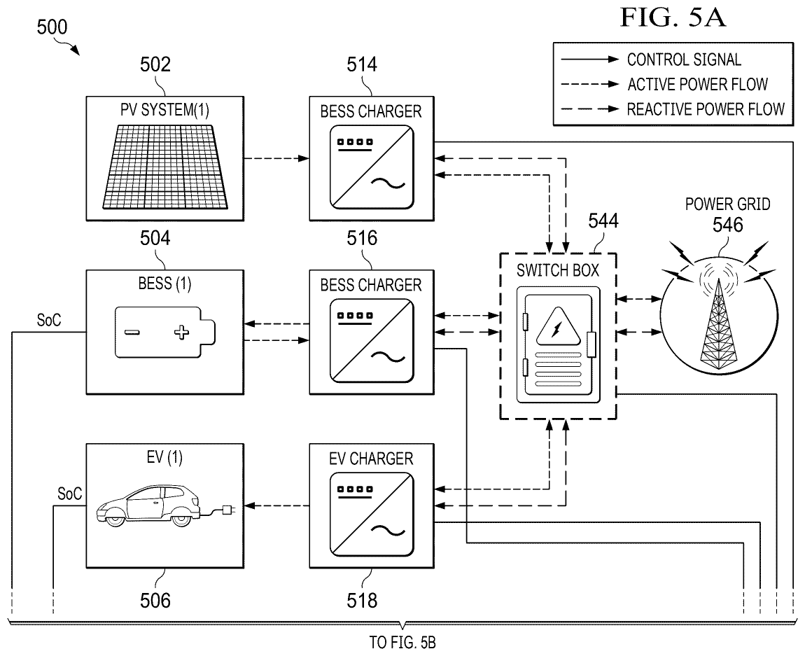

FIG. 4 is a diagram of a system 400 showing modes of operation of residential n-Grids in accordance with an example embodiment of the present disclosure. System 400 includes n-Grids 402, mode one 404, mode 2 406, mode 3 408, electric market operator and aggregator 410, and utility distribution system operator 412, each of which can be implemented in hardware or a suitable combination of hardware and software.

N-Grids 402 are a plurality of n-Grids coupled to one or both of electric market operator and aggregator 410 and utility distribution system operator 412, such as by service agreements or in other suitable embodiments. Each n-Grid 402 can be independently owned and operated, or can authorize electric market operator and aggregator 410 and utility distribution system operator 412 to control operational attributes.

Mode one 404 includes n-Grids that are coupled to a market operator via an aggregator. Mode 2 406 includes n-Grids that are coupled to utility distribution system operator 412 with or without an aggregator. Mode 3 408 includes n-Grids in a peer-to-peer exchange with utility distribution system operator 412 and with or without an aggregator. These three modes define different agreements between the owners of n-Grids 402 and electric market operator and aggregator 410 and utility distribution system operator 412, such as to allow the owners of n-Grids 402 to take advantage of different operational attributes. In this example embodiment, electric market operator and aggregator 410 and utility distribution system operator 412 could offer different levels of value-added services to the owners of n-Grids 402, could provide different service areas or could otherwise provide operational functions that are different from each other.

Electric market operator and aggregator 410 and utility distribution system operator 412 provide interconnection services for n-Grids. The nGRMS interfaced with the utility operators and market aggregators enables the n-Grid flexibility of providing services in different modes. An n-Grid can participate in the wholesale market ancillary service products through aggregator 410, or it can provide operational services to utility distribution system operator 412. It can also exchange power with other n-Grids in peer-to-peer operation with DSO coordination. The n-Grid provide the flexibility of EV and BESS active and reactive power support services to engage a utility distribution system operator 412 decision support tool called Customer Owned Resources Management System (CORMS). The services can include a) managing the SoR for utility grid assets, b) offering voltage regulation in the distribution grid, or other suitable services.

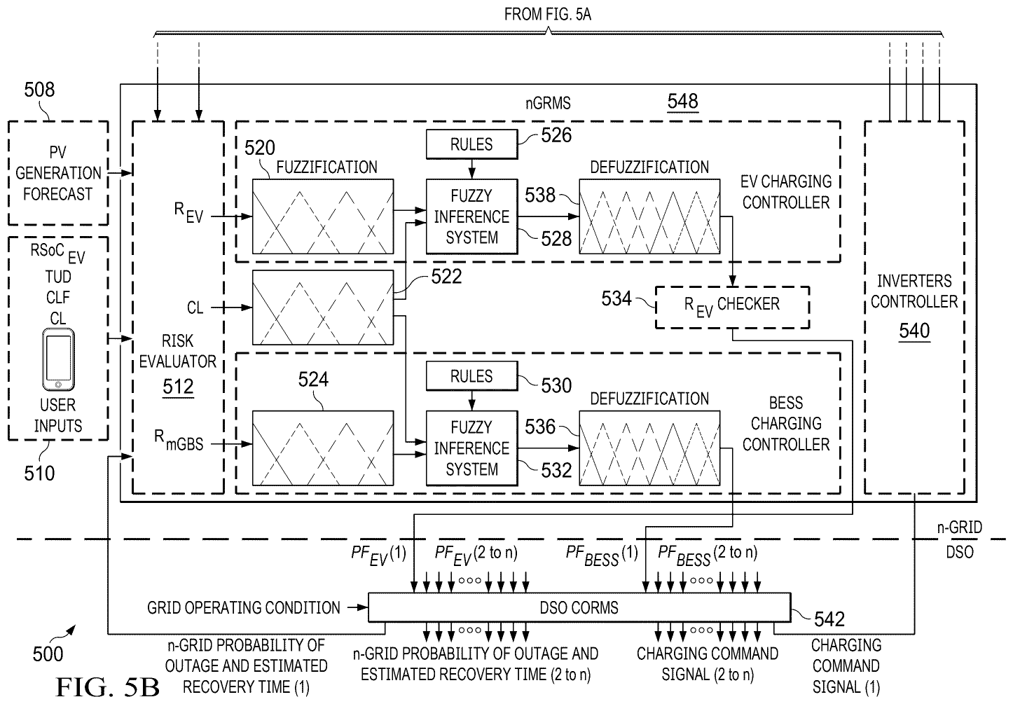

FIG. 5A and FIG. 5B are diagrams of a system 500 for providing fuzzy control of an n-Grid, in accordance with an example embodiment of the present disclosure. System 500 includes PV system 502, stationary battery system 504, electric vehicle 506, PV generation forecast 508, user inputs 510, risk evaluator 512, stationary battery charger 516, PV charger 514, EV battery charger 518, classification systems 520 through 524, rules 526 and 530, fuzzy interface system is 528 and 532, declassification systems 538 and 536, EV reliability checker 534, inverter controller 540, DSO corms 542, switchbox 544, power grids 546 and nGRMS 548, each of which can be implemented in hardware or suitable combination hardware and software.

PV system 502 can be implemented as one or more PV power systems that generate solar power and convert it into electrical power. PV systems 502 can be connected to PV charger 514 or other suitable systems.

Stationary battery system 504 can be implemented as one or more battery systems that are used to store backup power. In one example embodiment, stationary battery system 504 can be coupled to a stationary battery charger 516 or other suitable systems.

Electric vehicle 506 can be one or more electric vehicles that are used by an occupant of a dwelling. In one example embodiment, the electric vehicles can be coupled to EV battery charger 518 or other suitable systems.

PV generation forecast 508 can be implemented in hardware or a suitable combination of hardware and software, and can include one or more lines of code that are loaded into the working memory of a processor that cause the processor, when executed, to generate PV generation forecast data, as discussed and described herein.

User inputs 510 can be implemented in hardware or a suitable combination of hardware and software, and can include one or more lines of code that are loaded into the working memory of a processor that cause the processor, when executed, to generate one or more user controls and to receive user-entered inputs, as discussed and described herein.

Classification systems 520 through 524, rules 526 and 530, fuzzy interface systems 528 and 532 and declassification systems 538 and 536 can each be implemented in hardware or a suitable combination of hardware and software, and can include one or more lines of code that are loaded into the working memory of a processor that cause the processor, when executed, to receive a plurality of inputs and to perform logic processing of the inputs to generate outputs, as discussed and described herein.

EV reliability checker 534 can be implemented in hardware or a suitable combination of hardware and software, and can include one or more lines of code that are loaded into the working memory of a processor that cause the processor, when executed, to generate reliability data for an EV, as discussed and described herein. EV reliability checker 534 can determine whether an estimated time of departure is smaller than the required time to charge the EV to RSoC_{EV}, or other suitable data, and to determine whether or not an EV is not eligible to participate in system 500 operations.

Inverter controller 540 can be implemented in hardware or a suitable combination of hardware and software, and can include one or more lines of code that are loaded into the working memory of a processor that cause the processor, when executed, to control an operation state of PV charger 514, stationary battery charger 516, EV battery charger 518 and switch box 544, as discussed and described further herein. When an EV or stationary battery is selected to be utilized, inverter controller 540 can transmit the command back to nGRMS 548, which can be processed in the inverter controller to generate switching signals are sent to the stationary battery chargers and EV chargers.

DSO corms 542 can be implemented in hardware or a suitable combination of hardware and software, and can include one or more lines of code that are loaded into the working memory of a processor that cause the processor, when executed, to receive participation factor data and grid operating condition data and to generate grid outage probability. Recovery time estimates and charging command controls, as discussed and described herein.

Switchbox 544 can be a conventional switchbox with control functionality that is used to couple and decouple system 500 from power grids 546.

nGRMS 548 can be implemented in hardware or a suitable combination of hardware and software, and can include one or more lines of code that are loaded into the working memory of a processor that cause the processor, when executed, to receive and process user inputs and energy resources conditions, to generate an EV charging status index and a BESS charging status index, to provide the EV charging status index and the BESS charging status index to DSO CORMS 542, and to receive command signals from DSO CORMS 542 to control the EV and BESS inverters. System 500 includes stationary battery charger 516, EV battery charger 518 and PV charger 514, and is configured to manage each charger independently or in combination. User nGRMS 548 inputs are sent to DSO CORMS 542 and nGRMS 548 receives feedback data in real time.

Risk evaluator 512 can be implemented in hardware or a suitable combination of hardware and software, and can include one or more lines of code that are loaded into the working memory of a processor that cause the processor, when executed, to calculate an SoR for EV battery charger 518 and other suitable components. The user inputs can remain unchanged unless the user enters new settings. In one example embodiment, nGRMS 548 can receive 1) an EV State of Charge (SoC_{EV}) input as a real-time state of charge of the EV battery; 2) a Stationary Battery State of Charge (SoC_{BESS}) input that is a real-time state of charge of stationary battery 504; 3) a PV Generation Forecast associated with n-Grid PV system 502; 4) a EV RSoC (RSoC_{EV}) input that represents a number in percent and the departure time is the time when the EV owner needs the car to be charged, where at the departure time, the state of charge (SoC_{EV}) should be at least equal to RSoC_{EV}; 5) an Estimated Time of Next Departure (TUD) input that is a user's estimation of the time when he/she intends to leave and needs the vehicle to be charged; 6) a Critical Load Forecast (CLF) input that is a critical kWh demand in the next 24 hours that, if not supplied, will cause significant discomfort to the consumer; 7) a CL input that can be a number between 0 and 10 where 0 represents the most saving/least comfort and 10 is the lowest savings/highest comfort or other suitable values; 8) a Predicted Probability of Outage input that is a prediction of the probability of outage that the DSO calculates based on an n-Grid probability of outage formulation; 9) a predicted Recovery Time of the Potential Outage input that is a prediction that the DSO has of the time that it takes to recover from a potential outage; 10) Fuzzy Logic Rules as discussed further herein, with an output of the fuzzy system of a PF_{EV} for each EV and a PF_{BESS} for each stationary battery, and other suitable data.

DSO CORMS 542 can be configured to receive outputs from nGRMS 548, PF_{EV} data, PF_{BESS} data and other suitable data. Using PF_{EV} data and PF_{BESS} data and the SOR for utility grid transformers as well as utility grid voltage conditions, DSO CORMS 542 can determine which resources should be deployed using the decision-making process that is disclosed and described herein.

SoR formulation for EV and BESS in n-Grids can be based on a prediction of utility outages and n-Grid prediction of their loading and PV generation or other suitable factors. The SOR assessment can be used to manage resources in the n-Grid using a fuzzy-based controller developed for on-site use, and to generate an index for the DSO that represents an n-Grid assessment of their SoR. These functions can be integrated in the nGRMS. The outputs of the fuzzy controller in nGRMS can be named PF_{EV} and PF_{BESS} for EV and stationary batteries, respectively and can be used in the DSO decision-making process for deployment of n-Grid resources as discussed and described herein.

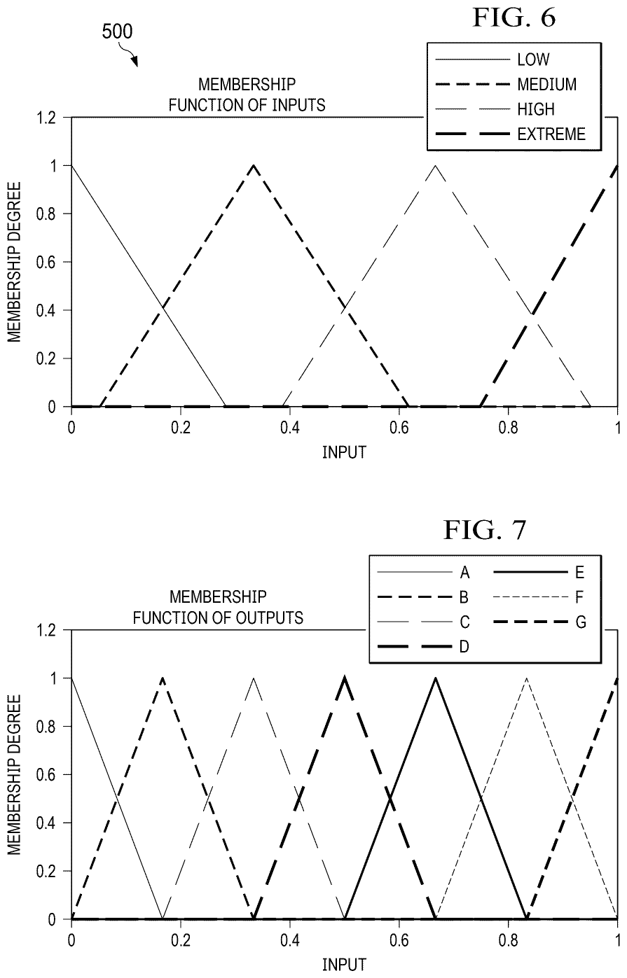

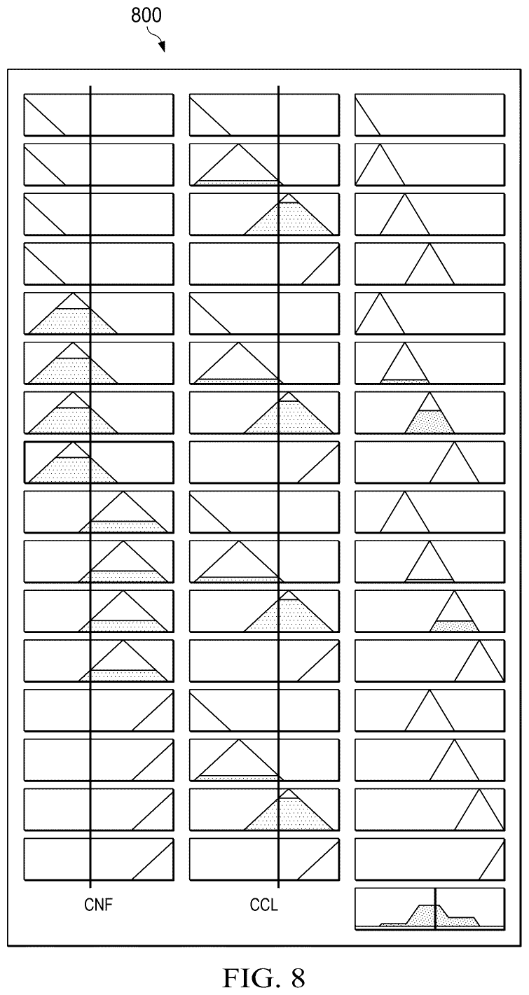

FIG. 6, FIG. 7, and FIG. 8 are diagrams 600 through 800 of a membership function of inputs in accordance with an example embodiment of the present disclosure. In one example embodiment, the membership function can be used in classification systems 520 through 524 or in other suitable manners. Based on the input values, four membership degrees are assigned to each input: low, medium, high, and extreme. Likewise, other suitable processes can also or alternatively be used. The output of system 600 for electric vehicle reliability and n-Grid energy sufficiency can represent the SOR levels for one or more EVs and stationary batteries, and a membership degree of the CL can also or alternatively be calculated. In one example embodiment, rules for a fuzzy inference system are shown in Table I.

TABLE I
Fuzzy Logic Inference System Rules.

| | CL Low | CL Medium | CL High | CL Extreme |
|---|---|---|---|---|
| SoR Low | D | E | F | G |
| SoR Medium | C | D | E | F |
| SoR High | B | C | D | E |
| SoR Extreme | A | B | C | D |

In this example embodiment, eight levels from “A” to “G,” are assigned for the membership function of the output of each fuzzy inference system. In the defuzzification layer, the outputs of both fuzzy systems are calculated using the centroid method, the membership function shown in diagram 700 and a suitable process, such as that disclosed in E. H. Mamdani and S. Assilian, “An experiment in linguistic synthesis with a Fuzzy logic controller,” International Journal of Man-Machine Studies, vol. 7, no. 1, pp. 1-13, 1975, which is incorporated by reference for all purposes as if set forth herein in its entirety, or other suitable processes. As an example, if EV risk is 0.45 and CL is 0.6, the output of the fuzzy system is calculated as shown in diagram 800, and the output is the center of that area includes all membership areas of the output that is 0.536.

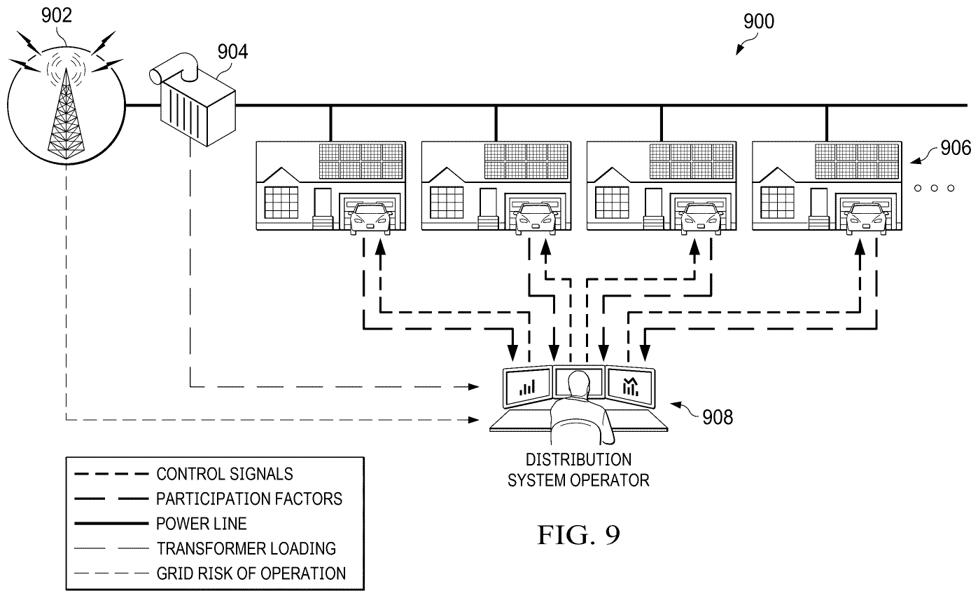

FIG. 9 is a diagram of a system 900 for distributed controls in accordance with an example embodiment of the present disclosure. System 900 includes distribution system operator 908, power system 902, transformer 904, and n-Grids 906. The outputs of the on-site nGRMS, PF_{EV} and PF_{BESS} from each n-Grid 906 are sent to distribution system operator 908. Using PF_{EV} and PF_{BESS} and the SoR for transformer 904 as well as a voltage condition of power system 902, distribution system operator 908 can determine which resources should be deployed using a decision-making process, such as those discussed and described herein or other suitable processes.

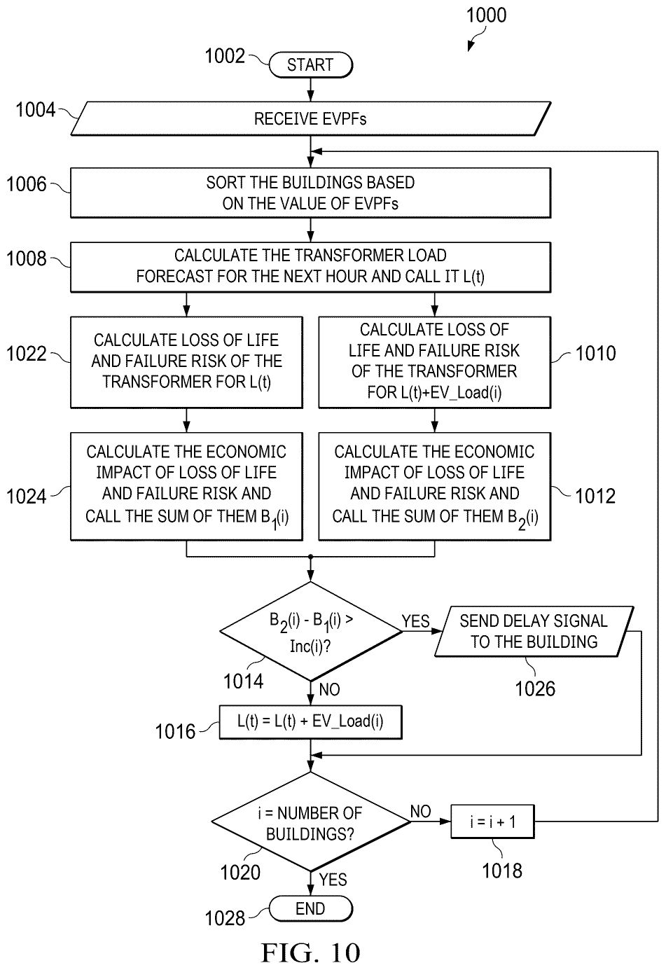

FIG. 10 is a diagram of an algorithm 1000 for processing data in accordance with an example embodiment of the present disclosure. Algorithm 1000 can be implemented in hardware or a suitable combination of hardware and software.

Algorithm 1000 starts at 1002 and proceeds to 1004 where PF_{EV}s are received. In one example embodiment, PF_{EV}s can be automatically generated, can be provided by users or can be generated in other suitable manners as discussed and described herein. The algorithm then proceeds to 1006.

At 1006, buildings are sorted based on the value of PF_{EV}. In one example embodiment, each building can be associated with one or more PF_{EV} and can be serviced by a single transformer, by multiple transformers that service subgroups of buildings or in other suitable manners as discussed and described herein. The algorithm that proceeds to 1008.

At 1008, the transformer load is calculated and forecast for the next hour. In one example embodiment, the transformer load can be calculated based on the number of buildings, the number of EVs or other suitable factors as discussed and described herein. The algorithm then proceeds to 1010.

At 1010, the loss of life and failure risk for the transformer is calculated for the normal load and for the EV charging load. In one example embodiment, the loss of life and failure risk for the transformer can be calculated based on load, EV charging load, the age of the transformer, ambient temperatures or other suitable factors as discussed and described herein. The algorithm also proceeds to 1022 where the loss of life and failure risk for the transformer is calculated for the load without the EV load. The algorithm then proceeds to 1024.

From 1010, the algorithm proceeds to 1012 where the economic impact of loss of life and failure of risk is calculated, and the sum of them is called B₂(i). The algorithm then proceeds to 1014.

At 1024, the economic impact of lost life and failure of risk is calculated and the sum of them is called B₁(i). The algorithm then proceeds to 1014.

At 1014, if B₂(i) minus B₁(i) is greater than I_{nc}(i) the algorithm proceeds to send delay signal building at 1026, otherwise the algorithm proceeds to 1016 where the new value of L(t) is updated to equal the current value of L(t) plus EV_load (i). The algorithm then proceeds to 1020 where the number of buildings is determined. The algorithm then proceeds to 1028 or returns to 1006 by incrementing (i).

If a difference that equals the saving of postponing the EV demand and not charging it for that hour is more than the incentive paid to the owner, then charging can be postponed and the operator can send a control (dispatch) signal to the household EV charging management system to postpone the charging of the EV. This process can be used for all households.

An optimum point can be achieved by selecting the n-Grid with the least value of PF_{EV} one-by-one, since they will receive the smallest amount of incentive if the charging of their EVs is delayed. The value can be evaluated if the paid incentive is less than the benefit that the distribution utility grid will gain from this delayed charging. If the value of the benefit is more than the incentive, the delay signal can be sent to the EV, and that EV can be removed from the set for that time slot. The EV with the next lowest PF_{EV} can be selected, and the same procedure can continue until the incentive is higher than the benefit.

Lemma: The output of the proposed decision-making algorithm reaches a global optimum.

Proof: K is defined as the set of all EVs available in parking and ready to be charged as shown in (51), where n is the number of available EVs for charging.

$$K ▯ \{ E {V}_{i} \vert i = 1 , 2 , … , n \} \qquad ( 51 )$$

I₁ is defined as the set of EVs which are selected not to be charged in the time slot using the decision-making algorithm. J₁ is the set of other EVs.

$${J}_{1} = K - {I}_{1} \qquad ( 52 )$$

Based on the logic of the decision-making process, the following statements are trivial. Incentive of x is the incentive paid to the household to delay charging of their EV and Benefit of x is the economic impact of delayed charging on the transformer.

$$∀ x ∈ {I}_{1} : Incentive of x < Benefit of x \qquad ( 53 )$$

$$∀ x ∈ {J}_{1} : Incentive of x > Benefit of x \qquad ( 54 )$$

The cost function is shown in (6.64).

$${Cost}_{1} = ( {\overbrace{{\sum }_{x ∈ {I}_{1}} Incentive of x}}^{{A}_{1}} - {\overbrace{{\sum }_{x ∈ {I}_{1}} Benefit of x}}^{{B}_{1}} ) - ( {\overbrace{{\sum }_{x ∈ {J}_{1}} Incentive of x}}^{{C}_{1}} - {\overbrace{{\sum }_{x ∈ {J}_{1}} Benefit of x}}^{{D}_{1}} ) \qquad ( 55 )$$

The postulate of contradiction is used to prove that the output of the decision-making algorithm reaches global optimum. Assume that there are two other sets I₂ and J₂, which are the set of selected and not selected EVs, respectively, for which the cost is less than Cost₁. This cost is called Cost₂ and is shown in (56).

$${Cost}_{2} = ( {\overbrace{{\sum }_{x ∈ {I}_{2}} Incentive of x}}^{{A}_{2}} - {\overbrace{{\sum }_{x ∈ {I}_{2}} Benefit of x}}^{{B}_{2}} ) - ( {\overbrace{{\sum }_{x ∈ {J}_{2}} Incentive of x}}^{{C}_{2}} - {\overbrace{{\sum }_{x ∈ {J}_{2}} Benefit of x}}^{{D}_{2}} ) \qquad ( 56 )$$

Based on the assumption, the following inequality holds:

$${Cost}_{2} < {Cost}_{1} ⇒ 0 < {Cost}_{1} - {Cost}_{2} = … ( {\overbrace{{\sum }_{x ∈ {J}_{1} ⋂ {I}_{2}} Benefit of x - {\sum }_{x ∈ {J}_{1} ⋂ {I}_{2}} Incentive of x}}^{A} ) … - ( {\overbrace{{\sum }_{x ∈ {I}_{1} ⋂ {J}_{2}} Benefit of x - {\sum }_{x ∈ {I}_{1} ⋂ {J}_{2}} Incentive of x}}^{B} ) > 0 \qquad ( 57 )$$

If x is a member of I₁∩J₂ or J₁∩I₂, then it is clearly a member of I₁ and J₁ respectively. Using the characteristics shown in (53) and (54) for the members of I₁ and J₁, B is positive and A is negative. Thus, A-B must be negative, which is contradictory to (57). Hence, there is no other solution with lower cost.

A close coordination of EV charging and PV generation, as well as their reactive power support is proposed to control the utility grid voltage. Although DSO CORMS functionalities explained herein help to mitigate voltage irregularities indirectly by making the load curve flatter, a voltage regulation capability can be provided by the DSO CORMS to ensure that the utility grid voltage remains in the required range.

Assume a load with active and reactive power of P and Q, respectively, is connected to node 2, and node 2 is connected to node 1 through a distribution feeder with resistance and reactance RL and XL, respectively. The load current can be calculated using (58).

$${I}_{L} = \frac{{\overline{S}}_{L}^{*}}{{\overline{E}}_{2}^{*}} = \frac{{P}_{L} - jQ}{{\overline{E}}_{2}^{*}} \qquad ( 58 )$$

Using (58) and the feeder parameters, the voltage drop caused by the load can be calculated using (59).

$$Δ V = \vert \overline{{E}_{2}} - \overline{{E}_{1}} \vert = \vert \overline{{I}_{L}} \cdot ( {R}_{L} + {jX}_{L} ) \vert \qquad ( 59 )$$

By substitute IL from (6.58) with the term calculated in (58) the voltage drop can be calculated using (60).

$$Δ V = \vert \frac{( {R}_{L} {P}_{L} + {X}_{L} {Q}_{L} ) + j ( {X}_{L} {P}_{L} - {R}_{L} {Q}_{L} )}{{\overline{E}}_{2}^{*}} \vert \qquad ( 60 )$$

Because of the small angle difference between the voltages of the nodes, the imaginary part is considerably smaller than the real part, and it can be neglected. The approximated voltage drop between the nodes can be calculated as sown in (61).

$$Δ V \approx \frac{{R}_{L} {P}_{L} + {X}_{L} {Q}_{L}}{{E}_{2}} \qquad ( 61 )$$

Using the superposition theorem, if there are other loads, the total voltage drop can be calculated by adding the voltage drop caused by each load.

The DSO CORMS receives voltage warning from the on-site nGRMS from one or more location. The first step for decision-making process is to determine the paths from substation to the nodes with critical voltage.

As explained herein, the utility grid downstream of the substation is defined as an undirected graph in which the utility grid buses are vertices of the graph, and the utility grid feeders are the edges. The vertex set can be defined by (62).

$$v = \{ 1 , 2 , … , n \} \qquad ( 62 )$$

Vertex 1 in the graph is the point of connection of the feeder to substation. The rest of the nodes are the buses of the distribution system. The edges of the graph are the lines and transformers that connect these nodes. The graph edges are defined in (63).

$$ε = \{ ( i , j ) : i , j ∈ v \} \qquad ( 63 )$$

If buses i and j are neighbors, then (i, j) is a graph edge. In other words, two buses are neighbors if they connect by a graph edge. The resistance and reactance matrices for edge (i, j) are defined by W_{R,ij} and W_{L,ij}. The graph is a connected graph because at least one path can be found from each node to every other node in the graph. Otherwise, there is an island in the utility grid which is out of the scope of this dissertation. In addition, it is assumed that the utility grid is radial and there are no loops in the graph.

Assume the DSO receives a voltage violation warning from an on-site nGRMS connected to node i. The first step of the algorithm is finding a path from vertex i to the substation which is vertex 1. The set of all edges in the path is called Γᵢ. The path can be found by iteratively trying the neighbors until the destination is met. Assume there is an EV or BESS in vertex j which can be used to support the utility grid voltage. Using the same approach, the path between vertex j and 1 can be obtained and the set of its edges is called Γⱼ. The intersection of these two paths is defined in (64).

$${Γ}_{i j} = \{ ( i , j ) : i , j ∈ {Γ}_{i} and i , j ∈ {Γ}_{j} \} \qquad ( 64 )$$

Deploying the resources in bus j can help regulate the voltage in bus i by decreasing or increasing the voltage in lines associated with the edges of Γᵢⱼ. Γᵢⱼ are the edges of a connected directed graph that starts from vertex 1 and ends at the last vertex at the intersection. The last vertex is k. Assume that the active and reactive power available to be injected into the utility grid in bus j is designated as P_{r,j} and Q_{r,j}, respectively.

Another important aspect to determine is whether the EV is connected to the same phase as the phase that suffers from undervoltage. Assume that the phase with undervoltage is phase A and the EV is connected to phase B. When the EV or BESS connects to more than one phase, its charging power or reactive power capacity is divided equally between the phases. If the phases are shown with two variables k and l, it means each of them can have a value from {A, B, C} set which represent phases A, B, and C, the effective resistance and reactance of managing the EV connected to phase k for compensating the undervoltage in phase 1 can be calculated as follows:

$${R}_{ij , kl} = {\sum }_{m} {W}_{R , m} ( k , l ) m ∈ {Γ}_{ij} , k , l ∈ \{ A , B , C \} \qquad ( 65 )$$

$${L}_{ij , kl} = {\sum }_{m} {W}_{L , m} ( k , l ) m ∈ {Γ}_{ij} , k , l ∈ \{ A , B , C \} \qquad ( 66 )$$

where W_{R,m}, and W_{L,m} are the resistance and reactance matrices, respectively. The impact of deploying the resources connected to phase k in bus j on the voltage of phase 1 in bus i can be calculated using (67) and (68).

$$Δ {V}_{P , ij , kl} = {R}_{ij , kl} \cdot {P}_{r , j} \qquad ( 67 )$$

$$Δ {V}_{Q , ij} = {L}_{ij , kl} \cdot {Q}_{r , j} \qquad ( 68 )$$

where P_{r,j} and Q_{r,j} are the active and reactive power capacity of resources in n-Grid r in bus j, respectively. PF_{EV} is used to calculate the incentive of each unit for active or reactive power services that the consumer can provide for EV charging. The incentives can be calculated by multiplying PFs into a fixed incentive rate that should be paid to the consumers, and where C_{P,EV,r,j} and C_{Q,EV,r,j} are the cost of deploying active and reactive power of EV number r connected to bus j, respectively. r is the number of the EVs under study among all EVs connected to bus j. P_{EV,r,j} and Q_{EV,r,j} are the available bandwidths of EV's inverter active and reactive power.

The term α_{EV,r,j} is a coefficient that determines whether the EV is eligible for controlling active power support by being shed and is defined in (69). INC_{EV,P} is the incentive paid for delaying EV charging ($/Wh). INC_{Q} is the predetermined incentive for reactive power support to the grid ($/VARh). P_{EV,r,j} and Q_{EV,r,j} are the active and reactive power supports provided by the EV, respectively.

$${α}_{EV , r , j} = \{ \begin{matrix}1 & {SoC}_{EV , r , j} + \frac{{P}_{r , j}}{{Cap}_{r , j}} < 100 \% \\ 0 & {SoC}_{EV , r , j} + \frac{{P}_{r , j}}{{Cap}_{r , j}} \geq 100 \%\end{matrix} \qquad ( 69 )$$

where SoC_{EV,r,j} is the state of charge. In these equations, r refers to the number of n-Grids in the node. The voltage regulation factor (VRF) index is also defined. VRFs for active and reactive power can be calculated as shown in (70) and (71). VRFs are the impacts that each resource has in regulating the voltage of the node that suffers from under- or over-voltage.

$${VRF}_{P , r , ij} = Δ {V}_{P , ij , kl} n ∈ Λ , k , l ∈ \{ A , B , C \} \qquad ( 70 )$$

$${VRF}_{Q , r , ij} = Δ {V}_{Q , ij , kl} n ∈ Λ , k , l ∈ \{ A , B , C \} \qquad ( 71 )$$

Where Λ is the set of vertices with voltage warning. In all equations, r refers to the number of n-Grids in the node. It is necessary that the apparent power of each inverter remains between zero and the nominal power of them. The apparent power can be calculated as shown in (72).

$${S}^{2} = {P}^{2} + {Q}^{2} ⇒ \frac{{P}^{2}}{{S}^{2}} + \frac{{Q}^{2}}{{S}^{2}} = 1 \qquad ( 72 )$$

Equation (72) is non-linear. To keep the optimization problem linear so that we can solve it with linear programming, a piecewise linear estimation of this equation can be used.

A piecewise linear formulation is described in (73) through (75). In the following equations, P is active power, Q is reactive power, and Sₙₒₘᵢₙₐₗ is the nominal power of the equipment.

$$P + \frac{0.5}{0.134} Q \leq \frac{0.5}{0.134} {S}_{nominal} \qquad ( 73 )$$

$$P + Q \leq 1.366 \cdot {S}_{nominal} \qquad ( 74 )$$

$$\frac{0.5}{0.134} P + Q \leq \frac{0.5}{0.134} {S}_{nominal} \qquad ( 75 )$$

An optimization problem is defined to calculate optimal deployment of the resources. The optimization objective is defined as follows,

$$Min {\sum }_{j = 1}^{n} {\sum }_{r = 1}^{n - {Grid}_{n}} \begin{matrix}[ ( ( {P}_{EV , r , j} = {P}_{EV , r , j}^{*} ) \cdot {INC}_{P} + ( {Q}_{EV , r , j}^{Capacitive} + {Q}_{EV , r , j}^{Reactive} ) \cdot {INC}_{Q} ) \cdot ( 1 - {PF}_{EV , r , j} ) + \\ ( ( {P}_{PV , r , j}^{*} - {P}_{PV , r , j} ) \cdot {INC}_{P} + ( {Q}_{PV , r , j}^{Capacitive} + {Q}_{PV , r , j}^{Reactive} ) \cdot {INC}_{Q} ) \cdot ( 1 - {PF}_{EV , r , j} ) ]\end{matrix} \qquad ( 76 )$$

$$subject to$$

$$- [ {V}_{Critical} + {\sum }_{j = 1}^{n} {\sum }_{r = 1}^{n - {Grid}_{n}} \begin{matrix}[ ( ( {P}_{EV , r , j}^{*} - {P}_{EV , r , j} ) \cdot {α}_{EV , r , j} + ( {P}_{PV , r , j}^{*} - {P}_{PV , r , j} ) ) \cdot {VRF}_{P , r , j} + \\ ( {Q}_{EV , r , j}^{Capacitive} - {Q}_{EV , r , j}^{Reactive} + {Q}_{PV , r , j}^{Capacitive} - {Q}_{PV , r , j}^{Reactive} ) \cdot {VRF}_{Q , r , j} ]\end{matrix} ] \leq - 0.95 \qquad ( 77 )$$

$$[ {V}_{Critical} + {\sum }_{j = 1}^{n} {\sum }_{r = 1}^{n - {Grid}_{n}} \begin{matrix}[ ( ( {P}_{EV , r , j}^{*} - {P}_{EV , r , j} ) \cdot {α}_{EV , r , j} + ( {P}_{PV , r , j}^{*} - {P}_{PV , r , j} ) ) \cdot {VRF}_{P , r , j} + \\ ( {Q}_{EV , r , j}^{Capacitive} - {Q}_{EV , r , j}^{Reactive} + {Q}_{PV , r , j}^{Capacitive} - {Q}_{PV , r , j}^{Reactive} ) \cdot {VRF}_{Q , r , j} ]\end{matrix} ] \leq 1.05$$

$${P}_{EV , r , j} + \frac{0.5}{0.134} ( {Q}_{EV , r , j}^{-} - {Q}_{EV , r , j}^{+} ) \leq \frac{0.5}{0.134} {S}_{nominal , EV , r , j} \qquad ( 78 )$$

$${P}_{EV , r , j} + \frac{0.5}{0.134} ( {Q}_{EV , r , j}^{+} - {Q}_{EV , r , j}^{-} ) \leq \frac{0.5}{0.134} {S}_{nominal , EV , r , j} \qquad ( 79 )$$

$${P}_{EV , r , j} + ( {Q}_{EV , r , j}^{-} - {Q}_{EV , r , j}^{+} ) \leq 1.366 \cdot {S}_{nominal , EV , r , j} \qquad ( 80 )$$

$${P}_{EV , r , j} + ( {Q}_{EV , r , j}^{+} - {Q}_{EV , r , j}^{-} ) \leq 1.366 \cdot {S}_{nominal , EV , r , j} \qquad ( 81 )$$

$$\frac{0.5}{0.134} {P}_{EV , r , j} + ( {Q}_{EV , r , j}^{+} - {Q}_{EV , r , j}^{-} ) \leq \frac{0.5}{0.134} {S}_{nominal , EV , r , j} \qquad ( 82 )$$

$$\frac{0.5}{0.134} {P}_{EV , r , j} + ( {Q}_{EV , r , j}^{+} - {Q}_{EV , r , j}^{-} ) \leq \frac{0.5}{0.134} {S}_{nominal , EV , r , j} \qquad ( 83 )$$

$${P}_{PV , r , j} + \frac{0.5}{0.134} ( {Q}_{PV , r , j}^{-} - {Q}_{PV , r , j}^{+} ) \leq \frac{0.5}{0.134} {S}_{nominal , PV , r , j} \qquad ( 84 )$$

$${P}_{PV , r , j} + \frac{0.5}{0.134} ( {Q}_{PV , r , j}^{+} - {Q}_{PV , r , j}^{-} ) \leq \frac{0.5}{0.134} {S}_{nominal , PV , r , j} \qquad ( 85 )$$

$${P}_{PV , r , j} + ( {Q}_{PV , r , j}^{-} - {Q}_{PV , r , j}^{+} ) \leq 1.366 \cdot {S}_{nominal , PV , r , j} \qquad ( 86 )$$

$${P}_{PV , r , j} + ( {Q}_{PV , r , j}^{+} - {Q}_{PV , r , j}^{-} ) \leq 1.366 \cdot {S}_{nominal , PV , r , j} \qquad ( 87 )$$

$$\frac{0.5}{0.134} {P}_{PV , r , j} + ( {Q}_{PV , r , j}^{+} - {Q}_{PV , r , j}^{-} ) \leq \frac{0.5}{0.134} {S}_{nominal , PV , r , j} \qquad ( 88 )$$

$$\frac{0.5}{0.134} {P}_{PV , r , j} + ( {Q}_{PV , r , j}^{+} - {Q}_{PV , r , j}^{-} ) \leq \frac{0.5}{0.134} {S}_{nominal , PV , r , j} \qquad ( 89 )$$

$${P}_{PV , r , j} , {Q}_{PV , r , j}^{+} , {Q}_{PV , r , j}^{-} , {P}_{EV , r , j} , {Q}_{EV , r , j}^{+} , {Q}_{EV , r , j}^{-} \geq 0 \qquad ( 90 )$$

$${P}_{PV , r , j} , {Q}_{PV , r , j}^{+} , {Q}_{PV , r , j}^{-} , {P}_{EV , r , j} , {Q}_{EV , r , j}^{+} , {Q}_{EV , r , j}^{-} ∈ ▯ \qquad ( 91 )$$

### Where

$${P}_{EV , r , j}^{⋆} and {P}_{PV , r , j}^{*}$$

are the active power consumption of the EV and active power generation of the PV before deployment for voltage regulation, respectively. P_{EV,r,j} and P_{PV,r,j} are the active power consumption of the EV and active power generation of the PV after deployment for voltage regulation, respectively. S_{nominal,EV,r,j} and S_{nominal,PV,r,j} are the nominal powers of the EV and PV inverters, respectively.

$${Q}_{PV , r , j}^{-} , {Q}_{PV , r , j}^{+} , {Q}_{EV , r , j}^{-} , and {Q}_{EV , r , j}^{+}$$

are the capacitive and inductive reactive power support of PV and EV inverters, respectively. r refers to the n-Grid number and j refers to the number of the bus that n-Grid is connected to. PF_{PV,r,j} is the participation factor for the PV system and is equal to PF_{BESS} because both are obtained using energy sufficiency SoR.

This decision-support tool can be used by a DSO to deploy the n-Grids resources and mitigate the transformers operation SoR. The DSO CORMS consists of two main control strategies which are day-ahead and real-time resource management. In the day-ahead, stationary battery energy storage charge scheduling, a linear optimization problem is formulated and is solved by linear programming algorithm for the day-ahead. The real-time EV charging management is performed using an algorithm that send delay commands to the EVs based on the user's assessment of EV charging SoR and the real-time condition of transformers. Finally, the voltage regulation functionality of the decision-support tool checks the real-time voltage in the utility grid and deploys available resources to mitigate under/over voltage as needed.

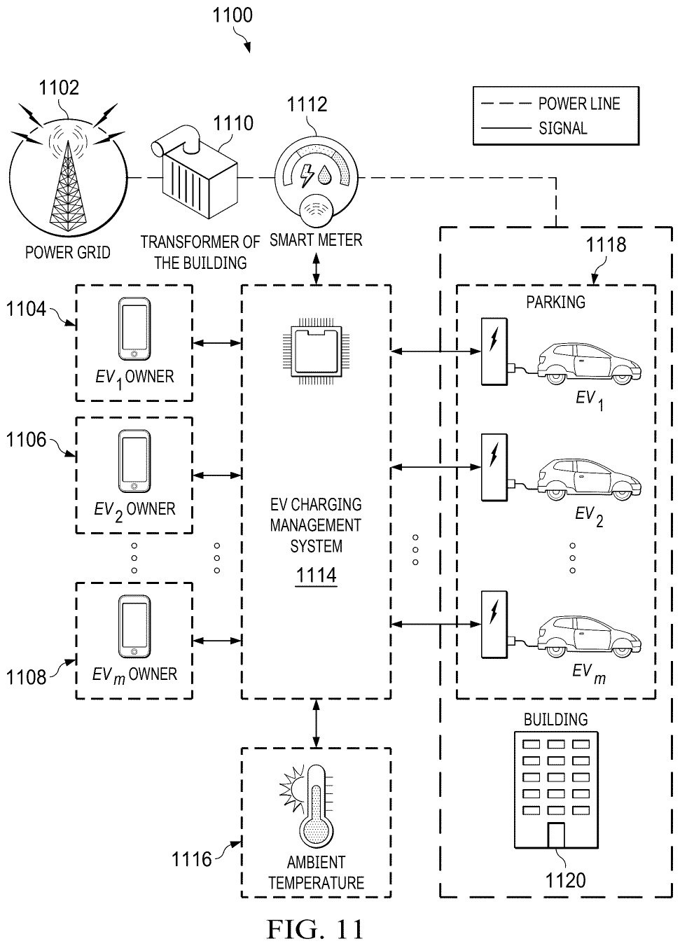

FIG. 11 as a diagram of a system 1100 for commercial grid applications and accordance with an example embodiment of the present disclosure. System 1100 includes power grid 1102, transformer of the building 1110, smart meter 1112, EV owner controls and associated EVs 1104 through 1108, EV charging management system 1114, ambient temperature measurement 1116, parking 1118 and building 1120.

Power grid 1102, transformer 1110 and smart meter 1112 are conventional electric distribution system components. EV owner controls and EVs 1104 through 1108 include associated EV owner input data and processors that can receive input data from each EV and EV owner, such as a CL, and can calculate an index, including a charging necessity factor (CNF). A user control can be generated to allow EV owners to select a CL, such as from 0 to 10, where CL 0 means that the customer selected the least level of comfort and highest level of saving, and the opposite is meant for level 10. Estimated time of the next departure data is used by the EV owner to provide an estimation of the next time of departure. The RSoC for the next trip is a state of charge needed for the next trip until the vehicle gets to a charging spot again, which can be reported as a percent or in other suitable manners. After receiving the inputs, a CNF can be calculated as discussed and described further herein that represents the SoR of not having the vehicle ready with enough charging at the time the EV owner needs to depart.

EV charging management system and 1114 ambient temperature measurement 1116 can be implemented as one or more algorithms that are loaded into the working memory of a processor that cause the processor, when executed, to control EV charging as a function of ambient temperature, such as to reduce charging when ambient temperatures lower the efficiency of charging, to reduce charging when additional energy storage is needed in case of loss of power or for other suitable purposes.

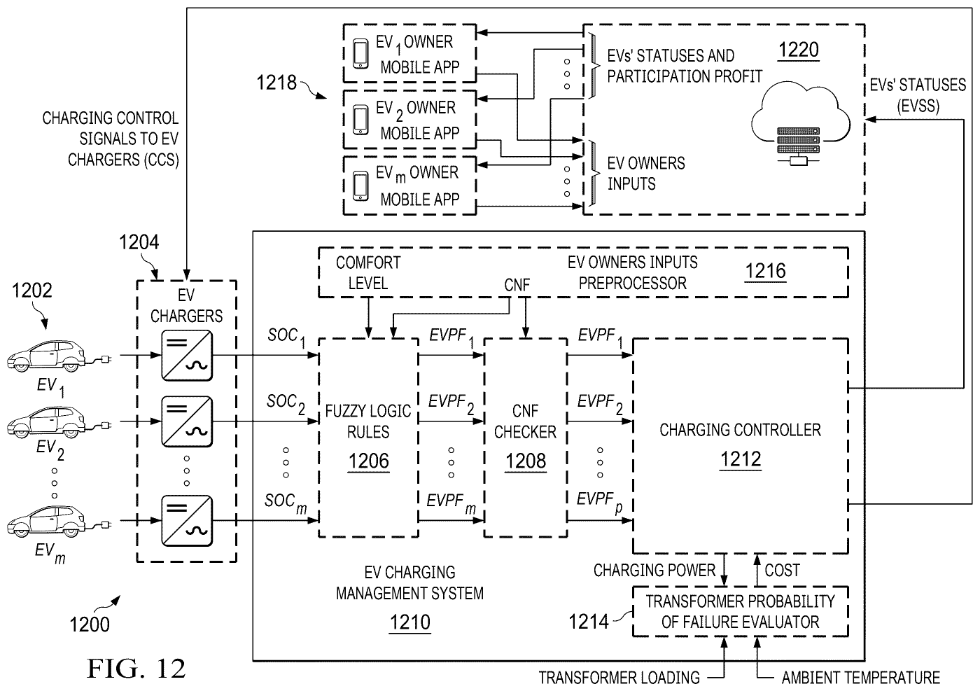

FIG. 12 is a diagram of a system 1200 for providing grid functionality. System 1200 includes EVs 1202, EV chargers 1204, fuzzy logic rules 1206, CNF checker 1208, EV charging management system 1210, charging controller 1212, transformer probability of failure evaluator 1214, EV owner mobile apps 1218, EV owner inputs and EV status monitors 1220 and charging control signals to EV chargers.

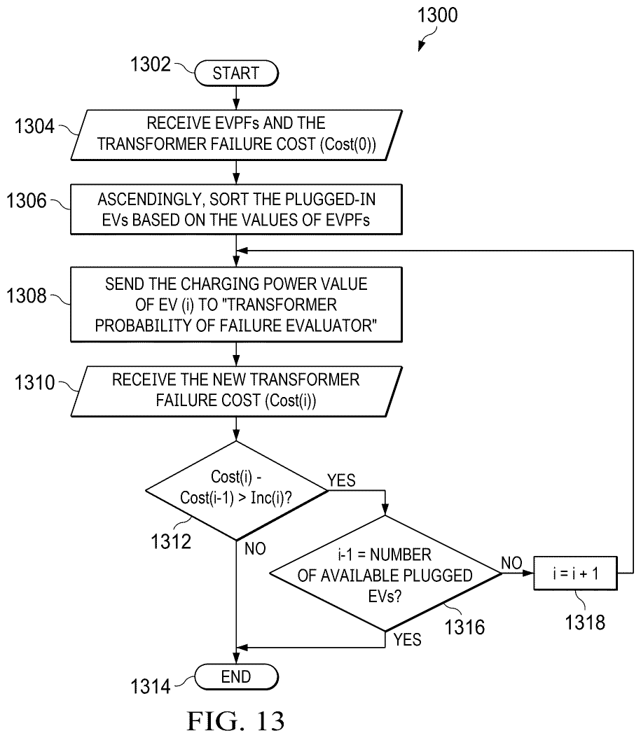

FIG. 13 is a diagram of an algorithm 1300 for managing electric vehicle charging, in accordance with an example embodiment of the present disclosure. Algorithm 1300 begins at 1302 and proceeds to 1304 where PF_{EV}s and transformer failure cost to received. In one example embodiment, the PF_{EV}s and transformer failure cost can be calculated, can be provided by a DSO CORMS or other suitable systems. The algorithm then proceeds to 1306.

At 1306, an ascending sort is performed for plugged-in EVs based on the value of PF_{EV}s. In one example embodiment, priority can be given to EVs that have a higher PF_{EV}, based on historical data or rate plan data or in other suitable manners. The algorithm then proceeds to 1308.

At 1308, the charging power values of EV (i) are sent to a transformer probability of failure evaluator or other suitable systems. In one example embodiment, the transformer probability of failure evaluator can evaluate the incremental increase in transformer probability of failure as a function of EV charging loads, or other suitable processes can also or alternatively be used. The algorithm procedures to 1310.

At 1310, the new transformer failure cost is received. In one example embodiment, the new transformer failure cost can be generated locally, by the transformer probability of failure evaluator, or other suitable processes can also or alternatively be used. The algorithm then proceeds to 1312.

At 1312, it is determined whether the cost is greater than a savings parameter. In one example embodiment, the savings parameter can be user-selected, can be dynamically generated or other suitable processes can also or alternatively be used. If the cost is not greater than the savings parameter, then the algorithm proceeds to 1314 and terminates. Otherwise, the algorithm proceeds to 1316 where it is determined whether the number whether (i−1) is equal to the number of available plugged EVs. If so, then the algorithm proceeds to 1314, otherwise the value of (i) is incremented and the algorithm returns to 1308.

The proposed architecture includes n charging slots in a parking lot, where the number of EVs connected to the chargers at time t is n(t). EV owners have a control device that is in communication with EV Charging Management System 1210, and can receive the status of EV charging for their EV, such as by generation of a control, an alert or in other suitable manners. The EV owners can then send control inputs in response to the notification data. EV chargers 1204 can send a request for a change in charge parameters to charge to management system 1210, and can receive charging control signals from management system 1210, which can also receive transformer loading from the smart meter as well as the ambient temperature from an online real-time source.

Fuzzy logic rules 1206 can be configured as a control tool to provide decision making using non-numerical and imprecise information. Considering that the factors used in the present disclosure are based on comfort of consumer and availability of EVs, which can be considered non-numerical and imprecise, fuzzy logic rules 1206 are a suitable option for this purpose. The functions used can be calculated in real-time, to provide values that are valid in real-time and that will change when the operating condition change in time. In the fuzzification layer of fuzzy logic rules 1206, four levels of SOR are defined for CNF and CL are defined as extreme, high, medium, and low. The fuzzy blocks fuse the two inputs of the fuzzification layer and calculates an index, the PF_{EVi} for EV i, which is a number between 0 and 10 and represents the availability of EV as well as the interest of EV owner in participating in charging management. Higher PF_{EV} values will lead to higher charging prices for the EV.

If time until departure is smaller than the needed time for EV to get to the required charging level, the CNF will be bigger than 1. This metric can be used to determine whether the EV can participate or has to be charged. CNF checker 1208 can be used to check whether the CNF of the EV calculated by Inputs Preprocessor 1216 is bigger than one and if it is, the associated EVAF should be removed from the inputs and the EV is marked as unavailable for participation. The number of EVs available for participation is assumed to be p.

Transformer probability of failure evaluator 1214 can use information of transformer loading, ambient temperature and other suitable data to generate a failure probability that is then sent to charging controller 1220, which can receive PF_{EV} values for all EVs currently getting charged as well as the cost calculated by the transformer probability of failure evaluator to selects EVs for which the charging should be delayed for the time step. Cost (i) is the cost associated with transformer loss of life and probability of failure if the charging of EVs 1 to i is delayed. Inc(i) is the charging credit given to the EV owner for EV participation in the mitigation program, which can be used to decrease the charging cost of an EV. The calculated i using the algorithm shows that the charging of the first i−1 EVs should be delayed for the time-step.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for load management, comprising:
a plurality of buildings, each building having an electric load and an electric vehicle charger;
a plurality of electric power transformers, each electric power transformer coupled to a subset of the plurality of buildings and configured to provide electric power to each of subset of the buildings as a function of the electric load of each of the building and the electric vehicle charger; and
a controller coupled to the plurality of electric power transformers, the controller configured to receive load data for each of the plurality of transformers and generate control data for one or more of the electric vehicle chargers as a function of the load data for the transformer associated with the electric vehicle charger.

2. The system of claim 1 further comprising a plurality of stationary battery systems, each stationary battery system coupled to one of the plurality of buildings, and wherein the controller is configured to generate control data for one or more of the stationary battery systems as a function of the load data for the transformer associated with the stationary battery system.

3. The system of claim 1 further comprising a plurality of temperature sensors each generating temperature data, each temperature sensor associated with one of the plurality of transformers, and wherein the controller is configured to generate control data for one or more stationary battery systems as a function of the temperature data generated by the temperature sensor associated with the transformer that is associated with the stationary battery system.

4. The system of claim 1 further comprising a plurality of building grid resource management systems, each building grid resource management system coupled to the electric load and the electric vehicle charger for the associated building and configured to control the associated electric load and the electrical vehicle charger.

5. The system of claim 1 further comprising a plurality of building grid resource management systems, each building grid resource management system coupled to a user control and the electric vehicle charger for the associated building and configured to generate a user interface for the user control to receive electrical vehicle charger controls from a user.

6. The system of claim 1 further comprising a plurality of building grid resource management systems, each building grid resource management system coupled to a user control, the electric load and the electric vehicle charger for the associated building and configured to generate a user interface for the user control to receive electric load controls and electrical vehicle charger controls from a user.

7. The system of claim 1 further comprising a plurality of building grid resource management systems, each building grid resource management system coupled to a user control and a stationary battery and configured to generate a user interface for the user control to receive stationary battery controls from a user.

8. The system of claim 1 further comprising a plurality of building grid resource management systems, each building grid resource management system coupled to a user control, the electric load and a stationary battery and configured to generate a user interface for the user control to receive electric load controls and stationary battery controls from a user.

9. The system of claim 1 further comprising a plurality of building grid resource management systems, each building grid resource management system coupled to a user control, the electric load, the electric vehicle charger and a stationary battery and configured to generate a user interface for the user control to receive electric load controls, electric vehicle controls and stationary battery controls from a user.

10. A method for load management, comprising:
providing electric power to each of a plurality of buildings as a function of an electric load of each of the building and an electric vehicle charger at each building;
receiving load data for each of a plurality of transformers at a controller; and
generating control data for one or more of the electric vehicle chargers as a function of the load data for the transformer associated with the electric vehicle charger.

11. The method of claim 10 further comprising generating control data for a stationary battery system as a function of the load data for the transformer associated with the stationary battery system.

12. The method of claim 10 further comprising generating control data for a stationary battery system as a function of temperature data at the transformer.

13. The method of claim 10 further comprising controlling the associated electric load and the electrical vehicle charger as a function of the electric load data for the transformer associated with the electric vehicle charger.

14. The method of claim 10 further comprising generating a user interface for a user control to receive electrical vehicle charger controls from a user.

15. The method of claim 10 further comprising generating a user interface for a user control to receive electric load controls and electrical vehicle charger controls from a user.

16. The method of claim 10 further comprising generating a user interface for a user control to receive stationary battery controls from a user.

17. The method of claim 10 further comprising generating a user interface for a user control to receive electric load controls and stationary battery controls from a user.

18. The method of claim 10 further comprising generating a user interface for a user control to receive electric load controls, electric vehicle controls and stationary battery controls from a user.
